(19) United States
(12) Patent Application Publication
(10) Pub. No.: US 2024/0289788 A1
(43) Pub. Date: Aug. 29, 2024

(54) BLOCKCHAIN-BASED DATA PROCESSING METHOD AND APPARATUS

(71) Applicant: Tencent Technology (Shenzhen) Company Limited, Shenzhen (CN)

(72) Inventor: Zimin CHEN, Shenzhen (CN)

(73) Assignee: Tencent Technology (Shenzhen) Company Limited, Shenzhen (CN)

(21) Appl. No.: 18/659,496

(22) Filed: May 9, 2024

Related U.S. Application Data
(63) Continuation of application No. PCT/CN2023/087202, filed on Apr. 10, 2023.

(30) Foreign Application Priority Data
May 10, 2022 (CN) 2022105040832

(51) Int. Cl. G06Q 20/38; G06Q 20/40; G06Q 30/0645

(52) U.S. Cl. CPC G06Q 20/389; G06Q 20/401; G06Q 30/0645

(57) ABSTRACT

The disclosure relates to the fields of artificial intelligence, blockchain, and traffic, and disclose a blockchain-based data processing method and apparatus. The method includes: uploading rental information regarding a virtual asset to a blockchain network; obtaining a rental request generated for the rental information, the rental request carrying resource transfer information of the virtual asset; transferring a target asset warrant of the virtual asset from an account address of the first object to an account address of the second object, and transferring the electronic resources of the numerical resource value from the account address of the second object to the account address of the first object; and determining a warrant attribute corresponding to the target asset warrant, generating a rental transaction record regarding the virtual asset based on the warrant attribute and the resource transfer information, and uploading the rental transaction record to the blockchain network.

### RELATED APPLICATION

This application is a continuation application of PCT Patent Application No. PCT/CN2023/087202, filed on Apr. 10, 2023, which claims priority to Chinese Patent Application No. 202210504083.2, filed with the China National Intellectual Property Administration on May 10, 2022 and entitled “BLOCKCHAIN-BASED DATA PROCESSING METHOD AND APPARATUS, DEVICE, AND STORAGE MEDIUM”, wherein the content of the above-referenced applications is incorporated herein by reference in its entirety.

### FIELD OF THE TECHNOLOGY

This disclosure relates to the fields of artificial intelligence, blockchain, and cloud technologies, and in particular, to a blockchain-based data processing method and apparatus, a device, and a storage medium.

### BACKGROUND OF THE DISCLOSURE

Due to characteristics such as decentralization and immutability, blockchain technologies can provide various digital items and physical items with proof of ownership in a form of a virtual asset with a unique characteristic, and store and distribute the proof in a distributed manner. Currently, after an asset issuer issues virtual assets in a blockchain network, a user registered with the blockchain network may obtain the issued virtual assets through promotion or direct purchases. A quantity of the virtual assets is usually limited, and therefore a single virtual asset has a high asset value. As a result, the virtual assets can be used only by a small quantity of users registered with the blockchain network, resulting in a relatively low utilization rate of the virtual assets.

### SUMMARY

An embodiment of this disclosure provides a blockchain-based data processing method, including:
uploading rental information regarding a virtual asset to a blockchain network, the rental information being for indicating that the virtual asset of a first object is in a rental pending state;
obtaining a rental request generated for the rental information, the rental request carrying resource transfer information of the virtual asset, the resource transfer information comprising a numerical resource value of electronic resources to be transferred by a second object for renting the virtual asset;
transferring a target asset warrant of the virtual asset from an account address of the first object to an account address of the second object, and transferring the electronic resources of the numerical resource value from the account address of the second object to the account address of the first object, the target asset warrant being for indicating that the first object has an ownership for the virtual asset; and
determining a warrant attribute corresponding to the target asset warrant, generating a rental transaction record regarding the virtual asset based on the warrant attribute and the resource transfer information, and uploading the rental transaction record to the blockchain network, the rental transaction record being for indicating that the second object has a use permission for the virtual asset but does not have a transfer permission for the virtual asset.

An embodiment of this disclosure provides a blockchain-based data processing apparatus, including a memory operable to store computer-readable instructions and a processor circuitry operable to read the computer-readable instructions. When executing the computer-readable instructions, the processor circuitry is configured to:
upload rental information regarding a virtual asset to a blockchain network, the rental information being for indicating that the virtual asset of a first object is in a rental pending state;
obtain a rental request generated for the rental information, the rental request carrying resource transfer information of the virtual asset, the resource transfer information comprising a numerical resource value of electronic resources to be transferred by a second object for renting the virtual asset;
transfer a target asset warrant of the virtual asset from an account address of the first object to an account address of the second object, and transfer the electronic resources of the numerical resource value from the account address of the second object to the account address of the first object, the target asset warrant being for indicating that the first object has an ownership for the virtual asset; and
determine a warrant attribute corresponding to the target asset warrant, generate a rental transaction record regarding the virtual asset based on the warrant attribute and the resource transfer information, and upload the rental transaction record to the blockchain network, the rental transaction record being for indicating that the second object has a use permission for the virtual asset but does not have a transfer permission for the virtual asset.

An embodiment of this disclosure provides a non-transitory machine-readable media, having instructions stored on the machine-readable media. The instructions are configured to, when executed, cause a machine to:
upload rental information regarding a virtual asset to a blockchain network, the rental information being for indicating that the virtual asset of a first object is in a rental pending state;
obtain a rental request generated for the rental information, the rental request carrying resource transfer information of the virtual asset, the resource transfer information comprising a numerical resource value of electronic resources to be transferred by a second object for renting the virtual asset;
transfer a target asset warrant of the virtual asset from an account address of the first object to an account address of the second object, and transfer the electronic resources of the numerical resource value from the account address of the second object to the account address of the first object, the target asset warrant being for indicating that the first object has an ownership for the virtual asset; and
determine a warrant attribute corresponding to the target asset warrant, generate a rental transaction record regarding the virtual asset based on the warrant attribute and the resource transfer information, and upload the rental transaction record to the blockchain network, the rental transaction record being for indicating that the second object has a use permission for the virtual asset but does not have a transfer permission for the virtual asset.

An embodiment of this disclosure provides a computer program product. The computer program product includes a computer program. the computer program, when executed by a processor, implements the operations of the method.

### BRIEF DESCRIPTION OF THE DRAWINGS

To describe technical solutions in embodiments of this disclosure or in the related art more clearly, drawings required for describing the embodiments or the related art are briefly described below. Apparently, the drawings in the following description show only some embodiments of this disclosure, and a person of ordinary skill in the art may derive other drawings from the drawings without creative efforts.

FIG. 1 is a schematic architecture diagram of a blockchain-based network system according to this disclosure.

FIG. 2 is a schematic diagram of a scenario of an interaction between a terminal and a node device in a blockchain network according to this disclosure.

FIG. 3 is a schematic diagram of a scenario of an interaction between a terminal and a node device in a blockchain network according to this disclosure.

FIG. 4 is a schematic flowchart of a blockchain-based data processing method according to this disclosure.

FIG. 5 is a schematic diagram of a scenario of determining a warrant attribute of a target asset warrant according to this disclosure.

FIG. 6 is a schematic flowchart of a blockchain-based data processing method according to this disclosure.

FIG. 7 is a schematic diagram of a scenario of joining a target game scene with a virtual asset according to this disclosure.

FIG. 8 is a schematic flowchart of a blockchain-based data processing method according to this disclosure.

FIG. 9 is a schematic structural diagram of a blockchain-based data processing apparatus according to an embodiment of this disclosure.

FIG. 10 is a schematic structural diagram of a computer device according to an embodiment of this disclosure.

### DESCRIPTION OF EMBODIMENTS

Technical solutions in embodiments of this disclosure are clearly and completely described below with reference to drawings in the embodiments of this disclosure. Apparently, the described embodiments are merely some rather than all of the embodiments of this disclosure. All other embodiments obtained by a person of ordinary skill in the art based on the embodiments of this disclosure without creative efforts fall within the protection scope of this disclosure.

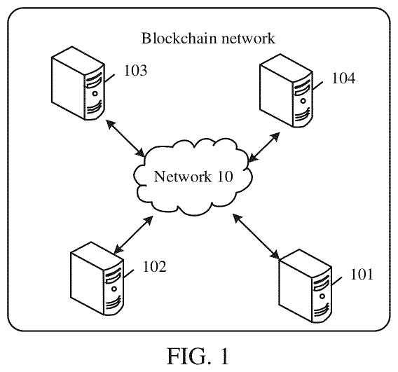

FIG. 1 is a schematic diagram of a network architecture according to an embodiment of this disclosure. Blockchain is a new application mode of computer technologies such as distributed data storage, point-to-point transmission, a consensus mechanism, and an encryption algorithm. The blockchain is mainly configured to organize data in chronological order and encrypt the data into a ledger, so that the data cannot be tampered with or forged, and the data may be verified, stored, and updated. The blockchain, in essence, is a decentralized database. Each node in the database has an identical blockchain stored therein. A blockchain network can classify nodes into consensus nodes and service nodes. The consensus nodes are configured for consensus of the entire blockchain network. A process of writing transaction data into a ledger in the blockchain network may be as follows: A client transmits the transaction data to a service node. Then the transaction data is successively delivered among the service nodes in the blockchain network until the consensus nodes receive the transaction data. Then the consensus nodes pack the transaction data into a block, and perform consensus processing with other consensus nodes. After a consensus is reached, the block carrying the transaction data is written into a ledger.

The block is a data packet carrying transaction data (that is, transaction businesses) on the blockchain network, which is a data structure marked with a timestamp and a hash value of a previous block. The block is verified through a consensus mechanism of the network, and a transaction in the block is determined.

First, a blockchain network to which this solution is applied is introduced. FIG. 1 is a schematic structural diagram of a blockchain network according to an embodiment of this disclosure. The blockchain network is an end-to-end decentralized network composed of a plurality of node devices. A quantity of the node devices in the blockchain network may be set according to an actual need. The quantity of the node devices is not limited in this disclosure. As shown in FIG. 1, a description is provided by using an example in which the blockchain network includes four node devices. The four node devices are respectively a node device 101, a node device 102, a node device 103, and a node device 104.

During normal operation, each node device may receive to-be-recorded data and maintain the blockchain based on the received to-be-recorded data. To ensure information communication within the blockchain network, a network connection 10 may exist among the node devices in the blockchain network, and data transmission may be performed between the node devices through the network connection 10. For example, when any node device in the blockchain network receives the to-be-recorded data, the other node devices in the blockchain network verify the to-be-recorded data based on a consensus algorithm. After the verification succeeds (that is, after a consensus is reached), the to-be-recorded data is stored as data in the blockchain. so that data stored in all node devices in the blockchain network is consistent.

Data or blocks may be transmitted among the node devices through the network connection 10. The network connection among the node devices may be based on a node identifier. Each node device in the blockchain network has a node identifier corresponding to the node device, and each node device may store a node identifier of another node device connected to the node device, so that the node device subsequently broadcasts obtained data or generated blocks to the another node device based on the node identifier of the another node device. For example, the node device 101 may maintain a node identifier list, the node identifier list having node names and node identifiers of the other node devices, as shown in Table 1.

TABLE 1

| Node name | Node identifier |
|---|---|
| Node device 101 | 117.xxx.xxx.174 |
| Node device 102 | 117.xxx.xxx.145 |
| . . . | . . . |
| Node device 111 | 117.xxx.xxx.183 |
| Node device 112 | 117.xxx.xxx.125 |
| Node device 113 | 119..xxx.xxx.362 |
| . . . | . . . |

The node identifier may be an Internet protocol (IP) address and any other piece of information that may be configured for identifying the node devices in the blockchain network. In Table 1, only the IP address is used as an example for description.

It is assumed that the node identifier of the node device 101 is 117.xxx.xxx.174. The node device 101 may transmit a data synchronization request to the node device 102 through 117.xxx.xxx.174. The node device 102 may learn, through the node identifier of 117.xxx.xxx.174, that the data synchronization request is transmitted by the node device 101. Similarly, the node device 102 may transmit transaction data A to the node device 101 through the node identifier 117.xxx.xxx.145. The node device 101 may learn, through the node identifier of 117.xxx.xxx.145, that the transaction data A is transmitted by the node device 101. The same is true for data transmission among other node devices.

A connection manner of the foregoing network connection is not limited. The network connection may be direct or indirect connection realized through wired communication, or may be direct or indirect connection realized through wireless communication, or may be realized in another connection manner, which is not limited in this disclosure.

The blockchain network in this disclosure may be a blockchain network based on a consortium blockchain (such as a consortium blockchain network based on Fabric). The consortium blockchain is a blockchain network that involves a plurality of organizations or institutions. In other words, the consortium blockchain is a cluster composed of a plurality of private chains, and is a blockchain network jointly managed by a plurality of institutions. Each organization or institution manages one or more node devices. Data thereof may be read, written, and transmitted only by different organizations within the system. For example, the blockchain network in this disclosure may be a consortium blockchain composed of one or more service devices of a game application. The consortium blockchain can ensure that a virtual asset of a game application can be transferred within the same game application, or that a virtual asset of a game application can be transferred between different game applications. In addition, each node device of the consortium blockchain usually has a corresponding entity organization, which may join or exit a network only after being authorized. The organizations and the institutions form a consortium with stakeholders to jointly maintain smooth operation of the blockchain. Specifically, the blockchain network based on the consortium blockchain has the following characteristics:

(1) In an embodiment, a consensus algorithm in the blockchain network based on the consortium blockchain may be customized by a management node device in the blockchain network based on the consortium blockchain. The management node device may be selected from the node devices in the blockchain network based on the consortium blockchain based on institution attributes of each institution (such as an institution to which the game application belongs). The institution attributes include one or more of a credit rating of the institution, an asset quantity of the institution, generation time of the institution, and the like. In another embodiment, the consensus algorithm in the blockchain network based on the consortium blockchain may be jointly customized by the node devices in the blockchain network based on the consortium blockchain.

(2) A consensus algorithm in this disclosure is followed by the node devices in the blockchain network based on the consortium blockchain. For example, the consensus algorithm specifies a rental condition for renting a virtual asset. If any node device in the blockchain network based on the consortium blockchain receives a rental request for the virtual asset, a consensus node device in the blockchain network based on the consortium blockchain needs to verify validity of the rental request for the virtual asset based on the consensus algorithm. If the rental request meets the rental condition in the consensus algorithm, it is determined that the rental request is valid, and the rental request may be executed.

(3) Decentralization. Unlike a public blockchain network, the blockchain network based on the consortium blockchain belongs to members of the consortium to some extent, and a consensus is easily reached therein, because only a limited quantity of node devices exist in the consortium blockchain.

(4) Strong controllability. The public blockchain network cannot be tampered with once formed, because generally massive node devices exist in the public blockchain network, and it is almost impossible to tamper with data on the blockchain. However, in the blockchain network based on the consortium blockchain, a transaction on the blockchain may be changed if a majority of all institutions reach a consensus.

(5) Data is not open by default. Unlike the public blockchain network, the data in the blockchain network based on the consortium blockchain is only accessible to the institutions in the consortium and users thereof.

The node device 101, the node device 102, the node device 103, and the node device 104 each may be an independent physical server, a server cluster composed of a plurality of physical servers, a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform.

An object in this disclosure may refer to a user. When the embodiments of this disclosure are applied to a specific product or technology, a user permission or consent needs to be obtained. Collection, use, and processing of user information of a user such as object attribute information (such as an object identifier and an account address) need to comply with relevant laws, regulations, and standards of relevant countries and regions. In other words, a computer device can obtain the user information of the user such as the object attribute information only when the computer device can obtain authorization information of the use for the information.

For example, the computer device may display a permission prompt interface on a user interface. The permission prompt interface is configured to prompt the user that the object attribute information of the user is currently being collected. After a confirmation operation performed by the user on the permission prompt interface is obtained, an operation of obtaining the object attribute information of the user is performed, or otherwise the process ends.

The virtual asset in this disclosure may refer to an asset that can be transferred on the Internet. For example, the virtual asset may refer to a game prop, a game device, a game skin, a game pet, or the like issued on the Internet by an institution to which a game application belongs. These virtual assets may be transferred in the game application. For example, a game prop may be exchanged between different game players. The virtual asset may alternatively be a digital famous painting, a TV production, or the like. The virtual asset has uniqueness, indivisibility, irreplaceability, and verifiability. The verifiability may mean that an affiliation of an ownership of the virtual asset may be verified, or the like. An electronic resource in the embodiments is an encapsulation of an electronic certificate of a specific amount. The electronic certificate may be either a digitized fiat currency or an electronic currency (for example, a game currency) that is issued by a third party and may be exchanged into a product or a service.

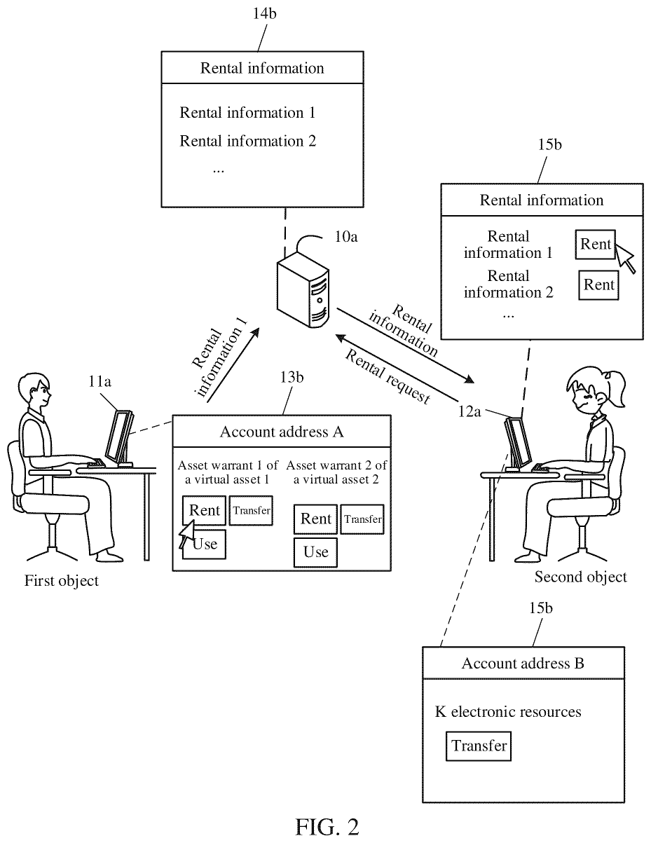

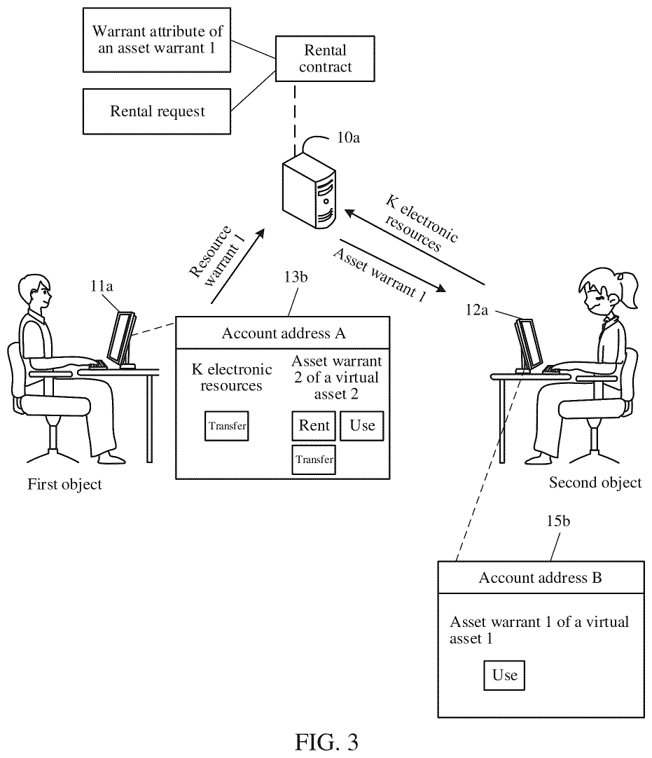

The node devices in the blockchain network shown in FIG. 1 can interact with a terminal, to implement a blockchain-based data processing method of this disclosure. An interaction process among the node devices in the blockchain network may be shown in FIG. 2 and FIG. 3. A node device 10a in FIG. 2 and FIG. 3 may refer to any node device in the blockchain network in FIG. 1. A terminal 11a in FIG. 2 and FIG. 3 may refer to a first terminal corresponding to a first object, and a terminal 12a may refer to a second terminal corresponding to a second object. As shown in FIG. 2, the first object has an account address A (labeled as 13b). At a moment T, the account address A of the first object includes an asset warrant 1 of a virtual asset 1 and an asset warrant 2 of a virtual asset 2. The first object has a rental permission, a transfer permission, and a use permission for each of the virtual asset 1 and the virtual asset 2. When the terminal 11a receives a rental instruction for the asset warrant 1 of the virtual asset 1, the terminal 11a may obtain rental information of the virtual asset 1 as rental information 1. The rental information 1 includes information such as a name, an asset value, and a purpose of the virtual asset 1. The rental information 1 is transmitted to each node device in the blockchain network.

After receiving the rental information 1, each node device may verify authenticity of the rental information. If the verification of the rental information 1 succeeds, each node device writes the rental information 1 to the blockchain in the blockchain network. As shown in FIG. 2, the node device 10a writes the rental information 1 to a block 14b. The block 14b further includes rental information 2, and may further include information such as a block header. Further, the node device 10a may transmit the rental information to the terminal 12a corresponding to the second object. The terminal 12a displays the rental information 1, the rental information 2, and the like on a rental information interface 15b. If detecting a touch operation performed on a rental option, the terminal 12a determines that the second object needs to rent the virtual asset 1. The terminal 12a generates a rental request carrying resource transfer information. The resource transfer information may also be referred to as payment information, and includes an account address of the second object and a numerical resource value of electronic resources to be transferred by the second object for renting the virtual asset 1. For example, the numerical resource value may be K. As shown in FIG. 2, at the moment T, an account address B of the second object includes K electronic resources. As shown in the interface 15b, the second object has a transfer permission for the K electronic resources.

As shown in FIG. 3, at a moment T+1, the node device 10a receives a rental request for the virtual asset 1. The node device transfers the asset warrant 1 of the virtual resource 1 to the account address B of the second terminal from the account address A of the first object, and transfers the K electronic resources to the account address A of the first object from the account address B of the second object. As shown in FIG. 3, the terminal 11a may display the newly-added K electronic resources in the account address A on the account interface 13b. The first object has a transfer permission for the K electronic resources. Correspondingly, the terminal 12a may display the newly-added asset warrant 1 in the account address B on the account interface 15b. The first object and the second object can view the respective account addresses to learn whether the current rental succeeds. Further, the node device 10a may obtain a warrant attribute of the asset warrant 1, and generate a transaction record such as rental contract based on the warrant attribute and the resource transfer information carried in the rental request. The rental contract is configured for indicating that the second object has a use permission for the virtual asset 1 and a transfer permission for the virtual asset 1 during a rental period and that the first object does not have an ownership for the virtual asset 1 during the rental period (for example, the ownership may include a rental permission, a transfer permission, and a use permission). Particularly, the rental contract may be configured for indicating that the second object has a rental permission for the virtual asset during the rental period. Alternatively, the rental contract may be configured for indicating that the second object does not have the rental permission for the virtual asset during the rental period. When the rental contract is configured for indicating that the second object has the rental permission for the virtual asset during the rental period, the second object may further rent the virtual asset 1 to another user. In this case, a rental period during which the second object rents the virtual asset 1 to the another user cannot exceed the period during which the first object rents the virtual asset 1 to the second object.

The terminal in this disclosure may be an on-board terminal, a smartphone, a tablet computer, a notebook computer, a desktop computer, a smart speaker, a screen speaker, or a smartwatch, but is not limited thereto. The use permission in this disclosure may refer to using the virtual asset as a condition for joining an activity. For example, a joining condition for joining a target game scene is that a user needs to have at least three virtual assets. Therefore, when the second object requests to join the target game scene, the computer device may verify whether the second object has three virtual assets. If the second object has three virtual assets, the second object is added to the target game scene. In this case, the second object joins the target game scene with the three virtual assets. The three virtual assets are still in the account address of the second object and are not transferred. The transfer permission may refer to allowing the asset warrant of the virtual asset to be transferred from the account address A to the account address B. After the asset warrant is transferred, an ownership of the asset warrant belongs to the object corresponding to the account address B. The rental permission may refer to allowing the asset warrant of the virtual asset to be transferred from the account address A to the account address B. After the asset warrant is transferred, the use permission of the asset warrant during the rental period belongs to the object corresponding to the account address B. After a system time period exceeds the rental period, the ownership of the asset warrant belongs to the object corresponding to the account address A. The ownership of the virtual asset includes a use permission, a transfer permission, and a rental permission.

Based on the above, a value of K electronic resources is much less than the asset value of the virtual asset 1. In other words, the second object can obtain the use permission for the virtual asset through renting only by spending a small quantity of electronic resources. To be specific, the second object only needs to pay a specific rent fee, but does not need to mortgage additional mortgage items or electronic resources, which can reduce costs required for the second object to participate in a virtual asset ecosystem, and improve a utilization rate of the virtual asset, and a device resource utilization rate and operating efficiency of the node devices of the blockchain.

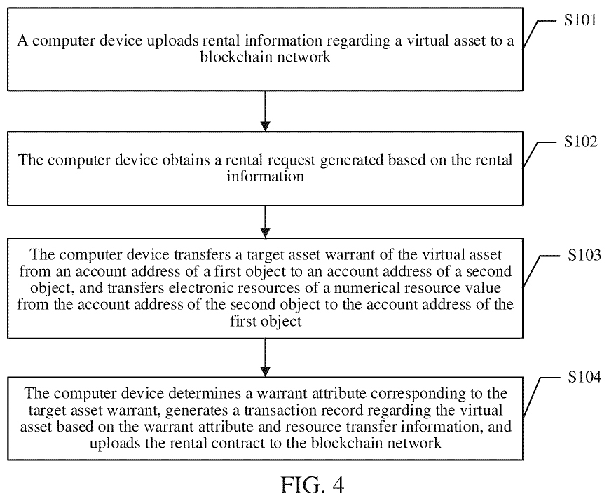

Further, FIG. 4 is a schematic flowchart of a blockchain-based data processing method according to an embodiment of this disclosure. As shown in FIG. 4, the method may be performed by any node device in FIG. 1, or may be performed by the terminal, or may be jointly performed by the terminal and the node device. All devices in this disclosure configured to perform the method may be collectively referred to as a computer device. The blockchain-based data processing method may include the following operation S101 to operation S104.

S101: The computer device uploads rental information regarding a virtual asset to a blockchain network, the rental information being configured for indicating that the virtual asset of a first object is in a rental pending state.

In this disclosure, if the first object has a spare virtual asset, or the first object needs to use the virtual asset of the first object, a first terminal corresponding to the first object may generate a rental request for the virtual asset. The rental request carries the rental information of the virtual asset and an object identifier of the first object that transmits a release request, and transmits the rental request to the computer device. The computer device may verify validity of the rental request. If the rental request is valid, the rental information is uploaded to the blockchain network. In this case, any user registered with the blockchain network can view the rental information and determine whether to rent the virtual asset based on a need of the user. The rental information may include a name of the virtual asset, a rentable period of the virtual asset, a rental fee, and the like.

Operation S101 may include the following operations: The computer device may obtain the release request for the rental information regarding the virtual asset, the release request carrying the rental information of the virtual asset and the object identifier of the first object that transmits the release request. Then the computer device determines a unit asset value of a unit asset quantity of virtual asset based on the release request, and verifies validity of the release request based on the object identifier of the first object and the unit asset value. If the release request is valid, the rental information regarding the virtual asset is uploaded to the blockchain network.

The computer device may obtain the release request for the rental information regarding the virtual asset from the first terminal corresponding to the first object. The release request carries the rental information of the virtual asset and the object identifier of the first object that transmits the release request. When the node device in the blockchain network releases the rental information to the blockchain network, each node device needs to store the rental information with a specific storage space. Moreover, the first terminal corresponding to the first object needs to transfer a fee for releasing the rental information to each node device. However, generally, if a virtual asset has a relatively low unit asset value, a user prefers to obtain a use permission for the virtual asset by purchasing. If rental information of the virtual asset having the relatively low unit asset value is released to the blockchain network, a success rate of renting the virtual asset is relatively low, which leads to a waste of storage resources of the node devices in the blockchain network and a waste of fees transferred by the first object for releasing the rental information. If a virtual asset has a relatively high unit asset value, a user prefers to obtain a use permission for the virtual asset by renting. If rental information of the virtual asset having the relatively low unit asset value is released to the blockchain network, a success rate of renting the virtual asset is relatively high, which improves a utilization rate of the storage resources of the node devices in the blockchain network, and improve a utilization rate of fees spent by the first object in releasing the rental information. Therefore, to improve the success rate of renting the virtual asset, the computer device may determine the unit asset value of the unit asset quantity of the virtual asset based on the release request. The unit asset value may refer to an asset value of one virtual asset. Then the validity of the release request is verified based on the object identifier of the first object and the unit asset value. If the release request is valid, the rental information regarding the virtual asset is uploaded to the blockchain network. Verifying the validity of the release request is verified based on the unit asset value and the object identifier of the first object can effectively avoid release of rental information corresponding to an invalid release request to the blockchain network, thereby improving the utilization rate of the storage resources of the node devices in the blockchain network and improving the success rate of renting the virtual asset.

The computer device may verify the validity of the release request based on the object identifier of the first object and the unit asset value in either of the following two manners or a combination of the two manners.

Manner 1: The blockchain network is queried for asset warrants possessed by the first object based on the object identifier of the first object if the unit asset value is greater than an asset value threshold, to obtain a second asset warrant set. The blockchain network is queried for description information of the asset warrants in the second asset warrant set. The second asset warrant set is queried for an asset warrant of the virtual asset based on the description information. Then the queried asset warrant is determined as a target asset warrant of the virtual asset and it is determined that the release request is valid if the asset warrant of the virtual asset is queried from the second asset warrant set.

In the manner 1, if the unit asset value is less than or equal to the asset value threshold, the success rate of renting the virtual asset is relatively low. In this case, the computer device may reject to release the rental information to the blockchain network. If the unit asset value is greater than the asset value threshold, the success rate of renting the virtual asset is relatively high. In this case, the computer device may query the blockchain network for the asset warrants possessed by the first object based on the object identifier of the first object, to obtain the second asset warrant set, and query the blockchain network for the description information of the asset warrants in the second asset warrant set. The description information of the asset warrants is configured for indicating virtual assets to which the asset warrants in the second asset warrant set respectively belong, namely, a virtual asset to which each asset warrant belongs. Then the second asset warrant set may be queried for the asset warrant of the virtual asset based on the description information. If the asset warrant of the virtual asset is queried from the second asset warrant set, and the queried asset warrant is determined as the target asset warrant of the virtual assets. It indicates that the first object has an ownership for the virtual asset. In other words, the virtual asset belongs to the first object. The ownership includes a transfer permission and a use permission. Therefore, the computer device may determine that the release request is valid. The validity of the release request is verified through the asset warrant owned by the first object and the unit asset value of the virtual asset. In other words, a user having the virtual asset is allowed to release the rental information regarding the virtual asset only when the success rate of renting the virtual asset is relatively high, so as to prevent an unauthorized user from releasing the rental information regarding the virtual asset, thereby improving rental security of the virtual asset.

Manner 2: The blockchain network is queried for a credit rating of the first object based on the object identifier of the first object if the unit asset value is greater than the asset value threshold. If the credit rating of the first object is greater than a rating threshold, it is determined that the release request is valid.

In the manner 2, if the unit asset value is less than or equal to the asset value threshold, the success rate of renting the virtual asset is relatively low. In this case, the computer device may reject to release the rental information to the blockchain network. If the unit asset value is greater than the asset value threshold, the success rate of renting the virtual asset is relatively high. In this case, the computer device may query the blockchain network for the credit rating of the first object based on the object identifier of the first object. The credit rating may be determined based on one or more of a quantity of times the first object abides by a rental contract, a duration of registration in the blockchain network, and a total asset quantity of the virtual asset possessed by the first object. If the credit rating of the first object is less than or equal to the rating threshold, a probability that the first object abides by a rental contract is relatively small. Therefore, it may be determined that the release request of the first object is invalid, and the first object is not allowed to release the rental information. If the credit rating of the first object is greater than the rating threshold, the probability that the first object abides by a rental contract is relatively high. Therefore, it may be determined that the release request of the first object is valid, and the first object is allowed to release the rental information. The validity of the release request is verified through the credit rating of the first object and the unit asset value of the virtual asset. In other words, the user corresponding to the virtual asset is allowed to release the rental information regarding the virtual asset only when the success rate of renting the virtual assets is relatively high and the user has a relatively high credit rating, so as to prevent a user having a low credit rating from releasing the rental information regarding the virtual asset, thereby improving the rental security of the virtual asset.

S102: The computer device obtains a rental request generated based on the rental information, the rental request carrying resource transfer information of the virtual asset, the resource transfer information including a numerical resource value of electronic resources to be transferred by a second object for renting the virtual asset.

In this disclosure, if the second object browses the rental information in the blockchain network and determines that the second object needs to rent the virtual asset, a second terminal corresponding to the second object is triggered to generate the rental request based on the rental information and transmit the rental request to the computer device (for example, the node device in the blockchain network). The computer device may receive the rental request generated based on the rental information. The rental request carries the resource transfer information of the virtual asset. The resource transfer information includes the numerical resource value of the electronic resources that need to be paid by the second object for renting the virtual asset. The resource transfer information may further include an account address of the second object and the like.

S103: The computer device transfers a target asset warrant of the virtual asset from an account address of the first object to an account address of the second object, and transfers the electronic resources of the numerical resource value from the account address of the second object to the account address of the first object, the target asset warrant being configured for indicating that the first object has an ownership for the virtual asset.

In this disclosure, after receiving the rental request, the computer device may transfer the target asset warrant of the virtual asset from the account address of the first object to the account address of the second object, and transfer the electronic resources of the numerical resource value from the account address of the second object to the account address of the first object, the target asset warrant being configured for indicating that the first object has an ownership for the virtual asset. The electronic resources may refer to a valid currency circulating on the Internet. The asset value of the virtual asset is much higher than a value of the electronic resources of the numerical resource value. In other words, the second object obtains the use permission for the virtual asset having a higher asset value by using the electronic resources having a smaller asset value, which reduces costs required by the second object to participate in the virtual asset ecosystem and increases the utilization rate of the virtual asset.

S104: The computer device determines a warrant attribute corresponding to the target asset warrant, generates a rental contract regarding the virtual asset based on the warrant attribute and the resource transfer information, and uploads the rental contract to the blockchain network, the rental contract being configured for indicating that the second object has a use permission for the virtual asset but does not have a transfer permission for the virtual asset.

In this disclosure, the computer device may determine the warrant attribute corresponding to the target asset warrant. The warrant attribute includes a unique warrant attribute (which is also referred to as a first warrant attribute) and a universal warrant attribute (which is also referred to as a second warrant attribute). The unique warrant attribute is configured for indicating that the virtual asset has only one asset warrant, and the asset warrant has uniqueness, that is, the asset warrant is unique, and no other virtual asset has the same as the asset warrant as the virtual asset. The universal warrant attribute is configured for indicating that the virtual asset has M identical asset warrants. The M asset warrants are all the same, and the M asset warrants of the virtual asset are different from the asset warrants of other virtual assets. The M asset warrants may belong to the same user or at least two different users. An object having one of the M asset warrants has a partial ownership for the virtual asset. For example, an object having one asset warrant has an ownership for a specific share of the virtual asset. Further, the rental contract for the virtual asset is generated based on the warrant attribute and the resource transfer information, and the rental contract is uploaded to the blockchain network. The rental contract is configured for indicating that the second object has the use permission for the virtual asset but does not have the transfer permission for the virtual asset during a rental period and that the first object does not have the ownership for the virtual asset during the rental period. Generating the rental contract is generated based on the warrant attribute and the resource transfer information helps ensure legitimate rights and interests of the first object and the second object, and improve rental fairness and security of the virtual asset. The rental contract is uploaded to the blockchain network, so that the rental process of the virtual asset is traceable and transparent.

The determining a warrant attribute corresponding to the target asset warrant in operation S104 includes: querying the blockchain network for asset warrants of the virtual asset to obtain a first asset warrant set, and counting a total quantity of the asset warrants in the first asset warrant set, the target asset warrant belonging to the first asset warrant set; determining the asset warrants in the first asset warrant set as the target asset warrant of the virtual asset and determining that the warrant attribute of the target asset warrant is a unique warrant attribute if the total quantity of the asset warrants in the first asset warrant set is 1, an object having the asset warrant with the unique warrant attribute having a full ownership for the virtual asset; and determining that an asset warrant of the M asset warrants belonging to the first object as the target asset warrant of the virtual asset and determining that a warrant attribute of the target asset warrant is a universal warrant attribute if the total quantity of the asset warrants in the first asset warrant set is M, an object having the asset warrant with the universal warrant attribute having a partial ownership for the virtual asset, and M being a positive integer greater than or equal to 2.

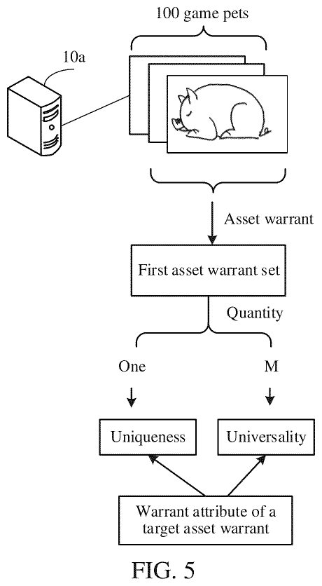

As shown in FIG. 5, a node device 10 in FIG. 5 may refer to any node device in the blockchain network in FIG. 1, and the virtual asset may refer to 100 game pets. A computer device (that is, the node device 10a) may query the blockchain network for asset warrants of the virtual asset to obtain a first asset warrant set, and count a total quantity of the asset warrants in the first asset warrant set. If the total quantity of the asset warrants in the first asset warrant set is 1, the asset warrant in the first asset warrant set is the target asset warrant. In this case, it is determined that a warrant attribute of the target asset warrant is a unique warrant attribute. An object having the asset warrant with the unique warrant attribute has a full ownership for the virtual asset. In other words, the first object has the ownership of the virtual asset. The virtual asset belongs to only the first object. It is determined that the warrant attribute of the target asset warrant is a universal warrant attribute if the total quantity of the asset warrants in the first asset warrant set is M. An object having the asset warrant with the universal warrant attribute has a partial ownership for the virtual asset. M is a positive integer greater than or equal to 2.

For example, a correspondence between the M asset warrants and the virtual asset is shown in the following Table 2.

TABLE 2

| Asset warrant | Virtual asset |
|---|---|
| Asset warrant 1 | 20% |
| Asset warrant 2 | 5% |
| . . . | . . . |
| Asset warrant M | 7% |

As shown in Table 2 and FIG. 4 described above, a description is provided by using an example in which the virtual asset is 100 game pets. The virtual asset has M asset warrants, which may be referred to as an asset warrant 1, an asset warrant 2, . . . , an asset warrant M. Different asset warrants correspond to different shares of the virtual asset. For example, the asset warrant 1 corresponds to 20% of the virtual asset, the asset warrant 2 corresponds to 5% of the virtual asset, . . . , the asset warrant M corresponds to 7% of the virtual asset. Therefore, a user 1 with the asset warrant 1 has an ownership for 20 of the 100 game pets, a user 2 with the asset warrant 2 has an ownership for 5 of the 100 game pets, . . . , a user M with the asset warrant M has an ownership for 7 of the 100 game pets. In this case, attributes of the M asset warrants may be considered to be universal. Particularly, when the M asset warrants belong to the same user, the user has an ownership for the 100 game pets. As shown in FIG. 4, assuming that the 100 game pets have only one asset warrant M+1, and the asset warrant M+1 is possessed by a user M+1, the user M+1 has an ownership for the 100 game pets. When the virtual asset includes a plurality of asset warrants, a receiver to which these asset warrants are to be transmitted and a share of the virtual asset corresponding to each asset warrant are determined by an issuer of the virtual asset.

The generating a rental contract regarding the virtual asset based on the warrant attribute and the resource transfer information includes: determining a first asset quantity of the virtual asset possessed by the first object based on the warrant attribute; estimating an asset value of the virtual asset possessed by the first object based on the first asset quantity; determining, based on the asset value and the resource transfer information, a rental period during which the second object rents the virtual asset; generating first permission information of the first object for the virtual asset and second permission information of the second object for the virtual asset based on the rental period, the first permission information being configured for indicating that the first object does not have the ownership for the virtual asset within the rental period, and the second permission information being configured for indicating that the second object has the use permission for the virtual asset of the first asset quantity within the rental period but does not have the transfer permission for the virtual asset of the first asset quantity; and generating the rental contract regarding the virtual asset based on the first permission information and the second permission information.

Due to different warrant attributes of the target asset warrant, a share owned by the first object for the virtual asset is different. Therefore, the computer device may determine the first asset quantity of the virtual asset possessed by the first object based on the warrant attribute, and then may estimate the asset value of the virtual asset possessed by the first object based on the first asset quantity. The rental period during which the second object rents the virtual asset is determined based on the asset value and the resource transfer information. The rental period refers to a time period configured for limiting use of the virtual asset by the second object. Further, the first permission information of the first object for the virtual asset and the second permission information of the second object for the virtual asset are generated based on the rental period. The first permission information is configured for indicating that the first object does not have the ownership for the virtual asset during the rental period. In other words, the first object is not allowed to use, rent, or transfer the virtual asset during the rental period. The second permission information is configured for indicating that the second object has the use permission for the virtual asset of the first asset quantity but does not have the transfer permission for the virtual asset of the first asset quantity during the rental period. In other words, during the rental period, the second object is allowed to use the virtual asset, and the second object is not allowed to transfer the virtual asset. Then the rental contract regarding the virtual asset is generated based on the first permission information and the second permission information. Generating the rental contract based on the first permission information and the second permission information helps ensure legitimate rights and interests of the first object and the second object and improve the rental fairness and security of the virtual asset.

The determining a first asset quantity of the virtual asset possessed by the first object based on the warrant attribute includes: obtaining a total asset quantity of the virtual asset as a second asset quantity; determining the second asset quantity as the first asset quantity of the virtual asset possessed by the first object if the warrant attribute is the unique warrant attribute; and obtaining a share owned by the first object for the virtual asset from the blockchain network and determining the first asset quantity of the virtual asset possessed by the first object based on the second asset quantity and the share if the warrant attribute is the universal warrant attribute.

The computer device may obtain the total asset quantity of the virtual asset as the second asset quantity. If the warrant attribute is the unique warrant attribute, the first object has a full ownership for the virtual asset. Therefore, the second asset quantity may be determined as the first asset quantity of the virtual asset possessed by the first object. If the warrant attribute is the universal warrant attribute, a specific share of the virtual asset corresponds to an asset warrant. Therefore, the computer device may obtain the share owned by the first object of the virtual asset from the blockchain network, and determine a product of the second asset quantity and the share as the first asset quantity of the virtual asset possessed by the first object. Determining the first asset quantity of the virtual asset possessed by the first object through the warrant attribute means that the first object can rent only the virtual assets belonging to the first object, which improves the rental security and fairness of the virtual asset.

In this disclosure, the computer device may upload the rental information regarding the virtual asset to the blockchain network. The rental information is configured for indicating that the virtual asset of the first object is in the rental pending state. In this case, any user registered with the blockchain network may view the rental information and determine whether to rent the virtual asset based on a need of the user. Further, the computer device may obtain the rental request generated based on the rental information, the rental request carrying the resource transfer information of the virtual asset, the resource transfer information including the numerical resource value of the electronic resources to be transferred by the second object for renting the virtual asset; and transfer the target asset warrant of the virtual asset from the account address of the first object to the account address of the second object, and transfer the electronic resources of the numerical resource value from the account address of the second object to the account address of the first object, the target asset warrant being configured for indicating that the first object has the ownership for the virtual asset. Then the computer device may determine the warrant attribute corresponding to the target asset warrant, generate the rental contract regarding the virtual asset based on the warrant attribute and the resource transfer information, and upload the rental contract to the blockchain network, the rental contract being configured for indicating that the second object has the use permission for the virtual asset but does not have the transfer permission for the virtual asset. It may be learned that the blockchain network has recorded therein the rental information issued by the first object, the rental request transmitted by the second object, and the rental contract corresponding to the generated virtual asset during the renting of the virtual asset, and can further automatically update the permissions of the virtual assets possessed by the first object and the second object after the rental contract is generated and expires. On the one hand, security, reliability, transparency, and high credibility of the data information during the renting of the virtual asset is realized by using characteristics that it is difficult to tamper with the data of the blockchain network and the information recorded in the blockchain network is more authentic and reliable. On the other hand, if the first object has a spare virtual asset or the first object does not need to use the virtual asset possessed by the first object, the first object may rent the virtual asset possessed by the first object to the second object that needs the virtual asset, and the second object may transfer a specific rental fee to the first object, to improve the utilization rate of the virtual asset and the device resource utilization rate and operating efficiency of the node devices of the blockchain, and reduce the costs required by the second object to participate in the virtual asset ecosystem. In addition, after the second object obtains the target asset warrant of the virtual asset, the second object has the use permission for the virtual asset, and may use the virtual asset to participate in an on-line activity (for example, an activity in a game application), but the second object does not have the transfer permission for the virtual asset. In other words, the second object cannot transfer the virtual asset to others for use. In this way, a problem that the virtual asset cannot be returned to the first object after the rental contract is invalidated can be avoided, and the rental security and fairness of the virtual asset can be ensured.

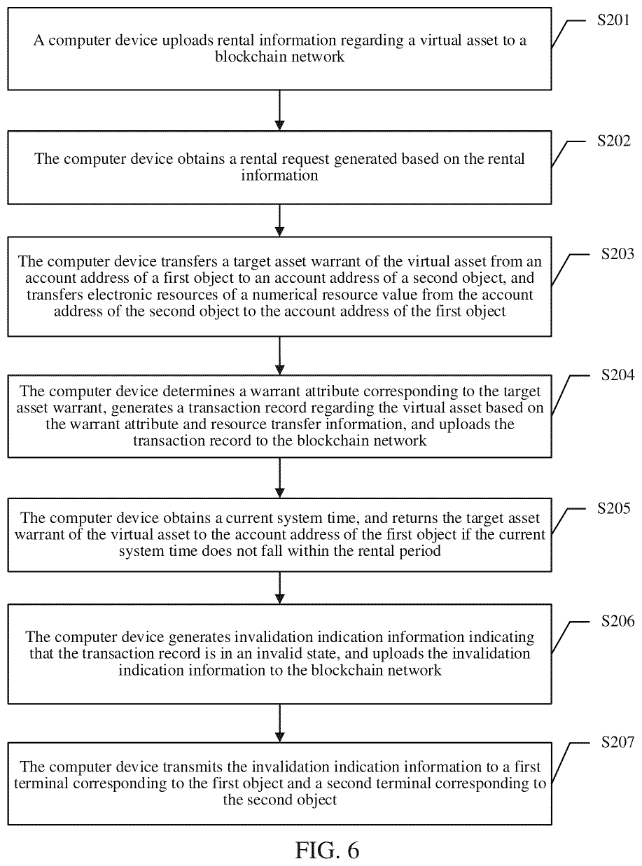

Further, FIG. 6 is a schematic flowchart of a blockchain-based data processing method according to an embodiment of this disclosure. As shown in FIG. 6, the method may be performed by any node device in FIG. 1, or may be performed by the terminal, or may be jointly performed by the terminal and the node device. All devices in this disclosure configured to perform the method may be collectively referred to as a computer device. The blockchain-based data processing method may include the following operation S201 to operation S207:

S201: The computer device uploads rental information regarding a virtual asset to a blockchain network, the rental information being configured for indicating that the virtual asset of a first object is in a rental pending state.

The first object and a second object are both users registered with the blockchain network. The computer device may complete the registration of a user in the following manner: The computer device may obtain an object registration request transmitted by a third terminal, the object registration request including an object identifier corresponding to the third terminal and an account address of a third object. Further, the computer device invokes a registration function in a smart contract in the blockchain network based on the object registration request, and obtains object attribute information of the third object corresponding to the third terminal based on the registration function. The object attribute information of the third object may include user information such as a name and an age. The computer device verifies validity of the third object based on the attribute information of the third object, for example, verifies whether the age of the third object meets a preset age. If the third object is invalid, the computer device rejects the registration request of the third object. If the third object is valid, the computer device associatively stores the account address corresponding to the third terminal and the object identifier corresponding to the third terminal to the blockchain network, to complete the registration of the third object in the blockchain network. Particularly, for registration processes of the first object and the second object in the blockchain network, reference may be made to the registration process of the third object in the blockchain network. Details refer to the embodiments described herein.

The account address of the third object may be generated based on a private key of the third object. For example, the account address of the third object may be a public key of the third object. The private key and the public key form a key pair. The public key is a public part of the key pair, and the private key is a non-public part. In addition to serving as the account address of the third object, the public key may be further configured to encrypt data verify a digital signature, and the like. The algorithm ensures that an obtained key pair is unique. When the key pair is used, if one key is used to encrypt a segment of data, another key needs to be used to decrypt the data. For example, if the data is encrypted with the public key, the data needs to be decrypted with the private key. If the data is encrypted with the private key, the data needs to be decrypted with the public key. Otherwise, the data cannot be decrypted.

S202: The computer device obtains a rental request generated based on the rental information, the rental request carrying resource transfer information of the virtual asset, the resource transfer information including a numerical resource value of electronic resources to be transferred by a second object for renting the virtual asset.

S203: The computer device transfers a target asset warrant of the virtual asset from an account address of the first object to an account address of the second object, and transfers the electronic resources of the numerical resource value from the account address of the second object to the account address of the first object, the target asset warrant being configured for indicating that the first object has an ownership for the virtual asset.

S204: The computer device determines a warrant attribute corresponding to the target asset warrant, generates a rental contract regarding the virtual asset based on the warrant attribute and the resource transfer information, and uploads the rental contract to the blockchain network, the rental contract being configured for indicating that the second object has a use permission for the virtual asset but does not have a transfer permission for the virtual asset.

S205: The computer device obtains current system time, and returns the target asset warrant of the virtual asset to the account address of the first object if the current system time does not fall within the rental period.

S206: The computer device generates invalidity indication information indicating that the rental contract is in an invalidity state, and uploads the invalidity indication information to the blockchain network.

S207: The computer device transmits the invalidity indication information to a first terminal corresponding to the first object and a second terminal corresponding to the second object, the invalidity indication information being further configured for indicating that the first object recovers the ownership for the virtual asset and that the second object loses the use permission for the virtual asset.

In operation S204 to operation S207, the computer device may obtain the current system time. If the current system time does not fall within the rental period of the rental contract, the rental period of the second object for the virtual asset expires. Therefore, the target asset warrant of the virtual asset is returned to the account address of the first object. The computer device may generate the invalidity indication information indicating that the rental contract is in the invalidity state, and uploads the invalidity indication information to the blockchain network. The computer device may transmit the invalidity indication information to the first terminal corresponding to the first object and the second terminal corresponding to the second object, the invalidity indication information being further configured for indicating that the first object recovers the ownership for the virtual asset and that the second object loses the use permission for the virtual asset. After the system time, the first object is allowed to transfer and use the virtual asset, but the second object is not allowed to use the virtual asset. After the rental contract expires, the permissions of the first object and the second object for the virtual asset are updated, and the updated permissions are recorded in the blockchain network, which realizes security, reliability, transparency, and high credibility of the data information during the renting of the virtual asset, and improves rental security and fairness of the virtual asset.

In some embodiments, if the computer device receives a transfer request for the virtual asset, the computer device may process the transfer request in the following manner: obtaining a transfer request for the virtual asset, the transfer request carrying an object identifier of a transferor; querying the blockchain network for transaction data associated with the virtual asset if the object identifier of the transferor is the same as the object identifier of the first object; executing the transfer request for the virtual asset if the transaction data associated with the virtual asset includes the rental contract for the virtual asset and includes the invalidity indication information of the rental contract for the virtual asset; and suspending the transfer request for the virtual asset if the transaction data associated with the virtual asset includes the rental contract for the virtual asset but does not include the invalidity indication information of the rental contract for the virtual asset.

The computer device may obtain the transfer request for the virtual asset. The transfer request carries the object identifier of the transferor. The object identifier of the transferor may be an account address transmitted by the transferor during registration in the blockchain network. Similarly, an object identifier of the first object may be an account address corresponding to the first object in the blockchain network, and an object identifier of the second object may be an account address of the second object in the blockchain network. Therefore, if the object identifier of the transferor is the same as that of the first object, the transfer request is transmitted by the first object. In this case, the computer device may query the blockchain network for the transaction data associated with the virtual asset. If the transaction data associated with the virtual asset includes the rental contract for the virtual asset and includes the invalidity indication information of the rental contract for the virtual asset, the rental contract expires. In other words, the first object recovers the ownership for the virtual asset. Therefore, the computer device may execute the transfer request for the virtual asset. If the transaction data associated with the virtual asset includes the rental contract for the virtual asset but does not include the invalidity indication information of the rental contract for the virtual asset, the rental contract does not expire. In other words, the first object does not have the ownership for the virtual asset (such as the use permission, the transfer permission, and the rental permission). Therefore, the computer device may suspend the execution of the transfer request for the virtual asset. When the first object needs to execute the transfer request on the virtual asset, the computer device detects whether the rental contract for the virtual asset expires. The transfer request is executed only when the rental contract for the virtual asset expires, which prevents a case that the second object cannot use the virtual asset during the rental period as a result of the first object transferring the virtual asset to another user during renting of the virtual asset to the second object, thereby helping ensure legitimate rights and interests of the second object and improving transfer security and rental security of the virtual asset.

In some embodiments, the computer device may suspend the execution of the transfer request and generate transfer suspension indication information if the object identifier of the transferor is the same as the object identifier of the second object, the transfer suspension indication information being configured for indicating that the second object does not have the transfer permission for the virtual asset; transmit the transfer suspension indication information to the second terminal corresponding to the second object, and upload the transfer request to the blockchain network; and adjust a credit rating of the second object based on the transfer request to obtain an adjusted credit rating, and suspend the execution of the rental request of the second object if the adjusted credit rating is less than a rating threshold.

If the object identifier of the transferor is the same as the object identifier of the second object, the transfer request is transmitted by the second object. Since the second object has the transfer permission for the virtual asset, the computer device may suspend the execution of the transfer request and generate the transfer suspension indication information, the transfer suspension indication information being configured for indicating that the second object does not have the transfer permission for the virtual asset. Then the computer device may transmit the transfer suspension indication information to the second terminal corresponding to the second object, and upload the transfer request to the blockchain network. Further, the credit rating of the second object is adjusted based on the transfer request, to obtain the adjusted credit rating. In other words, the credit rating of the second object is reduced based on the transfer request, to obtain the adjusted credit rating. A magnitude of the reduction may be determined based on at least one of a quantity of times the second object transfers the transfer request within a historical period and the asset value of the virtual asset. If the adjusted credit rating is less than the rating threshold, the second object does not abide by a rental contract a plurality of times. Therefore, when the rental request of the second object is subsequently received, the execution of the rental request of the second object is suspended. When a user without the transfer permission for the virtual asset transfers the virtual asset, the execution of the transfer request of the virtual asset is suspended, which helps ensure the legitimate rights and interests of the first object and improve the transfer security of the virtual asset.

This disclosure may be applied to fields such as multimedia and gaming. A description is provided below by using an example in which this disclosure is applied to the gaming field. Specifically, The computer device may obtain a joining request for a target game scene in a game application, and query the blockchain network for a joining condition for joining the target game scene based on the joining request, the joining request being configured for instructing to add the second object to the target game scene; then obtain game attribute information of the second object regarding the game application, and verify validity of the joining request based on the game attribute information, the rental contract, and the joining condition of the target game scene; generate joining permission information if the joining request is valid, the joining permission information being configured for indicating that the second object has a joining permission for the target game scene; and upload the joining permission information to the blockchain network, and transmit the joining permission information to an application server of the game application, the joining permission information being configured for instructing the application server to add the second object to the target game scene.

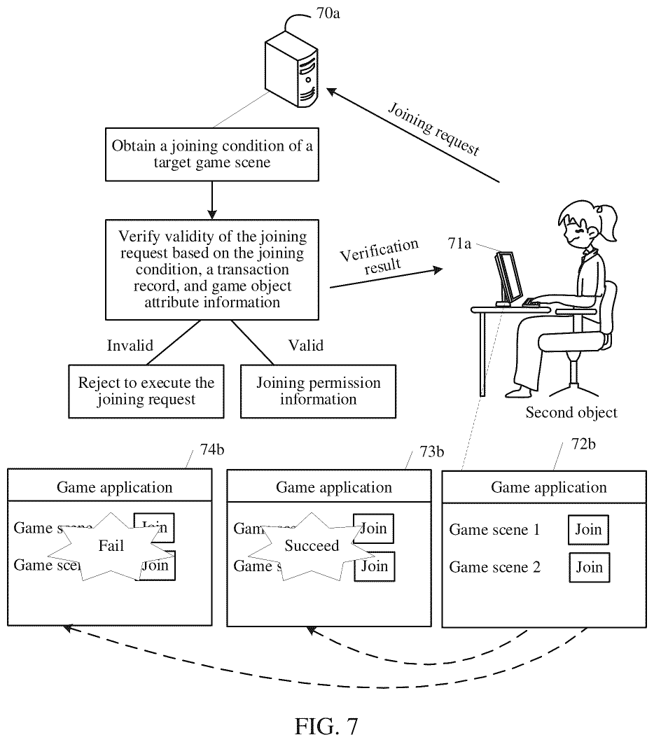

As shown in FIG. 7, a node device 70a in FIG. 7 may refer to any node device in the blockchain network in FIG. 1, and a terminal 71a may refer to the second terminal corresponding to the second object. The terminal 71a may display a game scene 1 and a game scene 2 of a game application on a game interface 72b. If a touch operation performed on the game scene 1 is received, the game scene 1 may be used as a target game scene of the game application, and a joining request for the target game scene is transmitted to the node device 70a. The computer device (that is, the node device 70a) may obtain the joining request for the target game scene in the game application, and query the blockchain network for a joining condition for joining the target game scene based on the joining request. The joining condition is configured for defining a condition for joining the target game scene. The target game scene may refer to a scene for logging into the game application, or one or more of a single-player game scene, a multiplayer battle game scene, a game practice scene, an indoor game scene, and a wild game scene. Then the computer device may obtain game attribute information of the second object regarding the game application. The game attribute information includes time at which the second object joins the game application, a game level in the game application, quantities of victories or defeats in the game application, and the like, and verifies validity of the joining request based on the game attribute information, the rental contract, and the joining condition of the target game scene, to obtain a verification result. The verification result indicates whether the joining request is valid or invalid. If the joining request is invalid, the second object does not meet the joining condition for joining the target game scene. In this case, the joining request is rejected. If the joining request is valid, the second object meets the joining condition for joining the target game scene. In this case, the joining permission information is generated. The joining permission information is configured for indicating that the second object has a joining permission for the target game scene. Further, the computer device may return the verification result to the terminal 71a. If the verification result indicates that the joining request is valid, the terminal 71a may display prompt information indicating successful joining on the interface 73b. If the verification result indicates that the joining request is invalid, the terminal 71a may display prompt information indicating unsuccessful joining on the interface 74b. Then the computer device uploads the joining permission information to the blockchain network, and transmits the joining permission information to an application server of the game application. The joining permission information is configured for instructing the application server to add the second object to the target game scene. The second object may be added to the game application in a manner of renting the virtual asset, which reduces costs required by the second object to participate in the virtual asset ecosystem, reduces a threshold for the second object to join the game application, and improve activeness of a game user.

In some embodiments, the verifying validity of the joining request based on the game attribute information, the rental contract, and the joining condition of the target game scene includes: determining, based on the rental contract, a rental period during which the second object rents the virtual asset and a first asset quantity of the virtual asset rented to the second object; determining a game level of the second object in the game application based on the game attribute information, and querying, based on the game level, the joining condition of the target game scene for a virtual asset quantity limit for the second object to join the target game scene; obtaining generation time of the joining request if the first asset quantity is greater than the virtual asset quantity limit; and determining that the joining request is valid if the generation time of the joining request falls within the rental period during which the second object rents the virtual asset.

The computer device may determine, based on the rental contract, the rental period during which the second object rents the virtual asset and the first asset quantity of the virtual asset rented to the second object, and determine the game level of the second object in the game application based on the game attribute information. Further, users of different game levels usually require different quantities of assets for joining the target game scene. Therefore, the computer device may query, based on the game level, the joining condition of the target game scene for the virtual asset quantity limit required for the second object to join the target game scene. The virtual asset quantity limit may be a minimum asset quantity required by a user of the game level to join the target game scene. If the first asset quantity is greater than the virtual asset quantity limit, the generation time of the joining request is obtained. If the generation time of the joining request falls within the rental period during which the second object rents the virtual asset, the second object has the use permission for the virtual asset. In this case, it is determined that the joining request is valid, and the second object meets the joining condition for joining the target game scene. The validity of the joining request of the second object for the target game scene is verified through the rental contract, the game attribute information, and the joining condition for joining the target game scene. In other words, the second object can properly use the virtual asset during the rental period, which ensures the legitimate rights and interests of the second object and improves a utilization rate of the virtual asset.

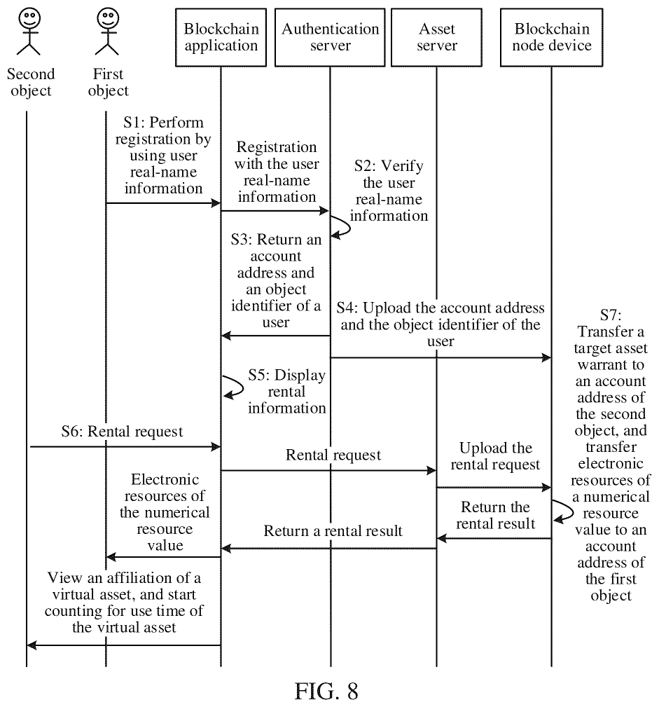

The first terminal corresponding to the first object and the second terminal corresponding to the second object each may include a blockchain client. The blockchain client may be a blockchain applet, a blockchain application, a blockchain webpage, or the like. A description is provided below by using an example in which the first terminal and the second terminal each have a blockchain application. Moreover, the computer device in this application may be an independent device or a set of a plurality of devices. For example, as shown in FIG. 8, the computer device may include an authentication server, an asset server, and a blockchain node device. Each device can implement the blockchain-based data processing method in this disclosure through interaction. An implementation process of this method includes the following S1 to S7.

S1: A first terminal corresponding to a first object may transmit a registration request to the authentication server through a blockchain application, the registration request carrying user real-name information of the first object, the user real-name information being an object attribute information of the first object. S2: The authentication server may verify the user real-name information of the first object after receiving the registration request of the first object, to obtain a verification result, perform operation S3 if the verification result indicates that the verification succeeds, and end the process if the verification result indicates that the verification fails. S3: The authentication server may return an object identifier and an account address of the first object to the first terminal based on the user real-name information of the first object. S4: The authentication server may transmit the object identifier and the account address of the first object to the blockchain node device (that is, a node device in a blockchain network), and the blockchain node device stores the object identifier and the account address of the first object in the blockchain. S5: The first terminal may transmit rental information of a virtual asset to an application server of the blockchain application, and the application server may display the rental information on the blockchain application, so that a user registered with the blockchain application (that is, the blockchain network) can view the rental information. S6: A second terminal corresponding to a second object may transmit a rental request to the asset server through the blockchain application, the asset server forwards the rental request to the blockchain node device, and the blockchain node device stores the rental request in the blockchain. S7: The blockchain node device may transfer a target asset warrant of the virtual asset from the account address of the first object to the account address of the second object, transfer electronic resources of a numerical resource value from the account address of the second object to the account address of the first object, generate a rental contract, and store the rental contract in the blockchain. Then, the blockchain node device returns a rental result to the asset server. The asset server returns the rental result to the first terminal and the second terminal. The first object may view the received electronic resources of the numerical resource value through the blockchain application. The second object may view an affiliation of the virtual asset through the blockchain application, and start counting for use time of the virtual asset.

In this disclosure, the computer device may upload the rental information regarding the virtual asset to the blockchain network. The rental information is configured for indicating that the virtual asset of the first object is in the rental pending state. In this case, any user registered with the blockchain network may view the rental information and determine whether to rent the virtual asset based on a need of the user. Further, the computer device may obtain the rental request generated based on the rental information, the rental request carrying the resource transfer information of the virtual asset, the resource transfer information including the numerical resource value of the electronic resources to be transferred by the second object for renting the virtual asset; and transfer the target asset warrant of the virtual asset from the account address of the first object to the account address of the second object, and transfer the electronic resources of the numerical resource value from the account address of the second object to the account address of the first object, the target asset warrant being configured for indicating that the first object has the ownership for the virtual asset. Then the computer device may determine the warrant attribute corresponding to the target asset warrant, generate the rental contract regarding the virtual asset based on the warrant attribute and the resource transfer information, and upload the rental contract to the blockchain network, the rental contract being configured for indicating that the second object has the use permission for the virtual asset but does not have the transfer permission for the virtual asset. It may be learned that the blockchain network has recorded therein the rental information issued by the first object, the rental request transmitted by the second object, and the rental contract corresponding to the generated virtual asset during the renting of the virtual asset, and can further automatically update the permissions of the virtual assets possessed by the first object and the second object after the rental contract is generated and expires. On the one hand, security, reliability, transparency, and high credibility of the data information during the renting of the virtual asset is realized by using characteristics that it is difficult to tamper with the data of the blockchain network and the information recorded in the blockchain network is more authentic and reliable. On the other hand, if the first object has a spare virtual asset or the first object does not need to use the virtual asset possessed by the first object, the first object may rent the virtual asset possessed by the first object to the second object that needs the virtual asset, and the second object may transfer a specific rental fee to the first object, to improve the utilization rate of the virtual asset and the device resource utilization rate and operating efficiency of the node devices of the blockchain, and reduce the costs required by the second object to participate in the virtual asset ecosystem. In addition, after the second object obtains the target asset warrant of the virtual asset, the second object has the use permission for the virtual asset, and may use the virtual asset to participate in an on-line activity (for example, an activity in a game application), but the second object does not have the transfer permission for the virtual asset. In other words, the second object cannot transfer the virtual asset to others for use. In this way, a problem that the virtual asset cannot be returned to the first object after the rental contract is invalidated can be avoided, and the rental security and fairness of the virtual asset can be ensured.

FIG. 9 is a schematic structural diagram of a blockchain-based data processing apparatus according to an embodiment of this disclosure. The blockchain-based data processing apparatus may be a computer program (including program code) running in a network device. For example, the blockchain-based data processing apparatus is application software. The apparatus may be configured to perform the corresponding operations in the method provided in the embodiments of this disclosure. As shown in FIG. 9, the blockchain-based data processing apparatus may include an uploading module 911, an obtaining module 912, a transfer module 913, and a generation module 914.

Here, the term “module” (and other similar terms such as unit, submodule, etc.) refers to computing software, firmware, hardware, and/or various combinations thereof Δt a minimum, however, modules are not to be interpreted as software that is not implemented on hardware, firmware, or recorded on a non-transitory processor readable recordable storage medium. Indeed “module” is to be interpreted to include at least some physical, non-transitory hardware such as a part of a processor, circuitry, or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices. The modules can be implemented in software stored in memory or non-transitory computer-readable medium. The software stored in the memory or medium can run on a processor or circuitry (e.g., ASIC, PLA, DSP, FPGA, or any other integrated circuit) capable of executing computer instructions or computer code. The modules can also be implemented in hardware using processors or circuitry on the same or different integrated circuit.

The uploading module is configured to upload rental information regarding a virtual asset to a blockchain network, the rental information being configured for indicating that the virtual asset of a first object is in a rental pending state.

The obtaining module is configured to obtain a rental request generated for the rental information, the rental request carrying resource transfer information of the virtual asset, the resource transfer information including a numerical resource value of electronic resources to be transferred by a second object for renting the virtual asset.

The transfer module is configured to transfer a target asset warrant of the virtual asset from an account address of the first object to an account address of the second object, and transferring the electronic resources of the numerical resource value from the account address of the second object to the account address of the first object, the target asset warrant being configured for indicating that the first object has an ownership for the virtual asset.

The generation module is configured to determine a warrant attribute corresponding to the target asset warrant, generate a rental contract regarding the virtual asset based on the warrant attribute and the resource transfer information, and upload the rental contract to the blockchain network, the rental contract being configured for indicating that the second object has a use permission for the virtual asset but does not have a transfer permission for the virtual asset.

In some embodiments, the generation module includes a query unit 91a and a determination unit 92a.

The query unit 91a is configured to query the blockchain network for asset warrants of the virtual asset to obtain a first asset warrant set, and count a total quantity of the asset warrants in the first asset warrant set, the target asset warrant belonging to the first asset warrant set.

The determination unit 92a is configured to: determine that the warrant attribute of the target asset warrant is a first warrant attribute if the total quantity of the asset warrants in the first asset warrant set is 1, an object having the asset warrant with the first warrant attribute having a full ownership for the virtual asset; and determine that the warrant attribute of the target asset warrant is a second warrant attribute if the total quantity of the asset warrants in the first asset warrant set is M, an object having one asset warrant with the second warrant attribute having a partial ownership for the virtual asset, and M being a positive integer greater than or equal to 2.

In some embodiments, the generation module further includes an estimation unit 93a and a generation unit 94a.

The determination unit 92a is configured to determine a first asset quantity of the virtual asset possessed by the first object based on the warrant attribute.

The estimation unit 93a is configured to estimate an asset value of the virtual asset possessed by the first object based on the first asset quantity.

The determination unit 92a is configured to determine, based on the asset value and the resource transfer information, a rental period during which the second object rents the virtual asset.

The generation unit 94a is configured to: generate first permission information of the first object for the virtual asset and second permission information of the second object for the virtual asset based on the rental period, the first permission information being configured for indicating that the first object does not have the ownership for the virtual asset within the rental period, and the second permission information being configured for indicating that the second object has the use permission for the virtual asset of the first asset quantity within the rental period but does not have the transfer permission for the virtual asset of the first asset quantity; and generate the rental contract regarding the virtual asset based on the first permission information and the second permission information.

In some embodiments, the determination unit 92a determining a first asset quantity of the virtual asset possessed by the first object based on the warrant attribute includes:
obtaining a total asset quantity of the virtual asset as a second asset quantity;
determining the second asset quantity as the first asset quantity of the virtual asset possessed by the first object if the warrant attribute is the first warrant attribute; and
obtaining a share owned by the first object for the virtual asset from the blockchain network and determining the first asset quantity of the virtual asset possessed by the first object based on the second asset quantity and the share if the warrant attribute is the second warrant attribute.

In some embodiments, the uploading module further includes an obtaining unit 95b, a verification unit 96b, and an uploading unit 97b.

The obtaining unit 95b is configured to obtain a release request for the rental information regarding the virtual asset, the release request carrying the rental information of the virtual asset and an object identifier of the first object transmitting the release request.

The verification unit 96b is configured to determine a unit asset value corresponding to a unit asset quantity of virtual asset based on the release request, and verify validity of the release request based on the object identifier of the first object and the unit asset value.

The uploading unit 96b is configured to upload the rental information regarding the virtual asset to the blockchain network if the release request is valid.

In some embodiments, the verification unit verifying validity of the release request based on the object identifier of the first object and the unit asset value includes:
querying the blockchain network for asset warrants possessed by the first object based on the object identifier of the first object if the unit asset value is greater than the asset value threshold, to obtain a second asset warrant set of the first object;
querying the blockchain network for description information of the asset warrants in the second asset warrant set, the description information being configured for indicating virtual assets to which the asset warrants in the second asset warrant set respectively belong;
querying the second asset warrant set for an asset warrant of the virtual asset based on the description information; and
determining the queried asset warrant as the target asset warrant of the virtual asset and determining that the release request is valid if the asset warrant of the virtual asset is queried from the second asset warrant set.

In some embodiments, the rental contract is further configured for indicating a rental period during which the second object rents the virtual asset. The obtaining module is further configured to:
obtain current system time;
return the target asset warrant of the virtual asset to the account address of the first object if the current system time does not fall within the rental period;
generate invalidity indication information indicating that the rental contract is in an invalidity state, and upload the invalidity indication information to the blockchain network; and
transmit the invalidity indication information to a first terminal corresponding to the first object and a second terminal corresponding to the second object, the invalidity indication information being further configured for indicating that the first object recovers the ownership for the virtual asset and that the second object loses the use permission for the virtual asset.

In some embodiments, the transfer module is further configured to:
obtain a transfer request for the virtual asset, the transfer request carrying an object identifier of a transferor;
query the blockchain network for transaction data associated with the virtual asset if the object identifier of the transferor is the same as the object identifier of the first object;
execute the transfer request for the virtual asset if the transaction data associated with the virtual asset includes the rental contract for the virtual asset and includes the invalidity indication information of the rental contract for the virtual asset; and
suspend the execution of the transfer request for the virtual asset if the transaction data associated with the virtual asset includes the rental contract for the virtual asset but does not include the invalidity indication information of the rental contract for the virtual asset.

In some embodiments, the transfer module is further configured to:
suspend the execution of the transfer request and generating transfer suspension indication information if the object identifier of the transferor is the same as the object identifier of the second object, the transfer suspension indication information being configured for indicating that the second object does not have the transfer permission for the virtual asset;
transmit the transfer suspension indication information to the second terminal corresponding to the second object, and upload the transfer request to the blockchain network; and
adjust a credit rating of the second object based on the transfer request to obtain an adjusted credit rating, and suspend the execution of the rental request of the second object if the adjusted credit rating is less than a rating threshold.

In some embodiments, the generation module is further configured to:
obtain a joining request for a target game scene in a game application, and querying the blockchain network for a joining condition for joining the target game scene based on the joining request, the joining request being configured for instructing to add the second object to the target game scene;
obtain game attribute information of the second object regarding the game application, and verifying validity of the joining request based on the game attribute information, the rental contract, and the joining condition of the target game scene;
generate joining permission information if the joining request is valid, the joining permission information being configured for indicating that the second object has a joining permission for the target game scene; and
upload the joining permission information to the blockchain network, and transmit the joining permission information to an application server of the game application, the joining permission information being configured for instructing the application server to add the second object to the target game scene.

In some embodiments, the generation module verifying validity of the joining request based on the game attribute information, the rental contract, and the joining condition of the target game scene includes:
determining, based on the rental contract, a rental period during which the second object rents the virtual asset and a first asset quantity of the virtual asset rented to the second object;
determining a game level of the second object in the game application based on the game attribute information, and querying, based on the game level, the joining condition of the target game scene for a virtual asset quantity limit required for the second object to join the target game scene;
obtaining generation time of the joining request if the first asset quantity is greater than the virtual asset quantity limit; and
determining that the joining request is valid if the generation time of the joining request falls within the rental period during which the second object rents the virtual asset.

In an embodiment, the uploading module is further configured to:
obtain an object registration request transmitted by a third terminal, the object registration request including an object identifier of a third object corresponding to the third terminal and an account address of the third object;
invoke a registration function in a smart contract in the blockchain network based on the object registration request;
obtain object attribute information of the third object based on the registration function, and verifying validity of the third object based on the attribute information of the third object; and
associatively store the account address corresponding to the third terminal and the object identifier corresponding to the third terminal in the blockchain network if the third object is valid.

According to an embodiment of this disclosure, the operations involved in the blockchain-based data processing method shown in FIG. 4 and FIG. 6 may be performed by the modules in the blockchain-based data processing apparatus shown in FIG. 9. For example, operation S101 shown in FIG. 4 may be performed by the uploading module 911 shown in FIG. 9, and operation S102 shown in FIG. 4 may be performed by the obtaining module 912 shown in FIG. 9. Operation S103 shown in FIG. 4 may be performed by the transfer module 913 shown in FIG. 9, and operation S104 shown in FIG. 4 may be performed by the generation module 914 shown in FIG. 9.

According to an embodiment of this disclosure, the modules in the blockchain-based data processing apparatus shown in FIG. 9 may be separately or all combined into one or a plurality of units, or one (or more) of the units may be further split into at least two small subunits by function, which can implement the same operations without affecting the implementation of the technical effects of the embodiments of this disclosure. The foregoing modules are divided based on logical functions. In an actual application, a function of one module may be implemented by at least two units, or functions of at least two modules are implemented by one unit. In other embodiments of this disclosure, the blockchain-based data processing apparatus may include another unit. In an actual application, these functions may be implemented with assistance of other units, and may be implemented with assistance of at least two units.

According to an embodiment of this disclosure, a computer program (including program code) that can perform the operations involved in the corresponding methods shown in FIG. 4 and FIG. 6 may be run on a general-purpose computer device such as a computer including processing components such as a central processing unit (CPU) and storage components such as a random access storage medium (RAM) and a read-only storage medium (ROM), to construct the blockchain-based data processing apparatus shown in FIG. 9 and implement the blockchain-based data processing method in the embodiments of this disclosure. The computer program may be recorded in, for example, a computer readable recording medium, and may be loaded into the computer device by using a computer-readable recording medium and run in the computer device.

In this disclosure, the computer device may upload the rental information regarding the virtual asset to the blockchain network. The rental information is configured for indicating that the virtual asset of the first object is in the rental pending state. In this case, any user registered with the blockchain network may view the rental information and determine whether to rent the virtual asset based on a need of the user. Further, the computer device may obtain the rental request generated based on the rental information, the rental request carrying the resource transfer information of the virtual asset, the resource transfer information including the numerical resource value of the electronic resources to be transferred by the second object for renting the virtual asset; and transfer the target asset warrant of the virtual asset from the account address of the first object to the account address of the second object, and transfer the electronic resources of the numerical resource value from the account address of the second object to the account address of the first object, the target asset warrant being configured for indicating that the first object has the ownership for the virtual asset. It may be learned that the blockchain network has recorded therein the rental information issued by the first object, the rental request transmitted by the second object, and the rental contract corresponding to the generated virtual asset during the renting of the virtual asset, and can further automatically update the permissions of the virtual assets possessed by the first object and the second object after the rental contract is generated and expires. On the one hand, security, reliability, transparency, and high credibility of the data information during the renting of the virtual asset is realized by using characteristics that it is difficult to tamper with the data of the blockchain network and the information recorded in the blockchain network is more authentic and reliable. On the other hand, if the first object has a spare virtual asset or the first object does not need to use the virtual asset possessed by the first object, the first object may rent the virtual asset possessed by the first object to the second object that needs the virtual asset, and the second object may transfer a specific rental fee to the first object, to improve the utilization rate of the virtual asset and the device resource utilization rate and operating efficiency of the node devices of the blockchain, and reduce the costs required by the second object to participate in the virtual asset ecosystem. Then the computer device may determine the warrant attribute corresponding to the target asset warrant, generate the rental contract regarding the virtual asset based on the warrant attribute and the resource transfer information, and upload the rental contract to the blockchain network, the rental contract being configured for indicating that the second object has the use permission for the virtual asset but does not have the transfer permission for the virtual asset. In addition, after the second object obtains the target asset warrant of the virtual asset, the second object has the use permission for the virtual asset, and may use the virtual asset to participate in an on-line activity (for example, an activity in a game application), but the second object does not have the transfer permission for the virtual asset. In other words, the second object cannot transfer the virtual asset to others for use. In this way, a problem that the virtual asset cannot be returned to the first object after the rental contract is invalidated can be avoided, and the rental security and fairness of the virtual asset can be ensured.

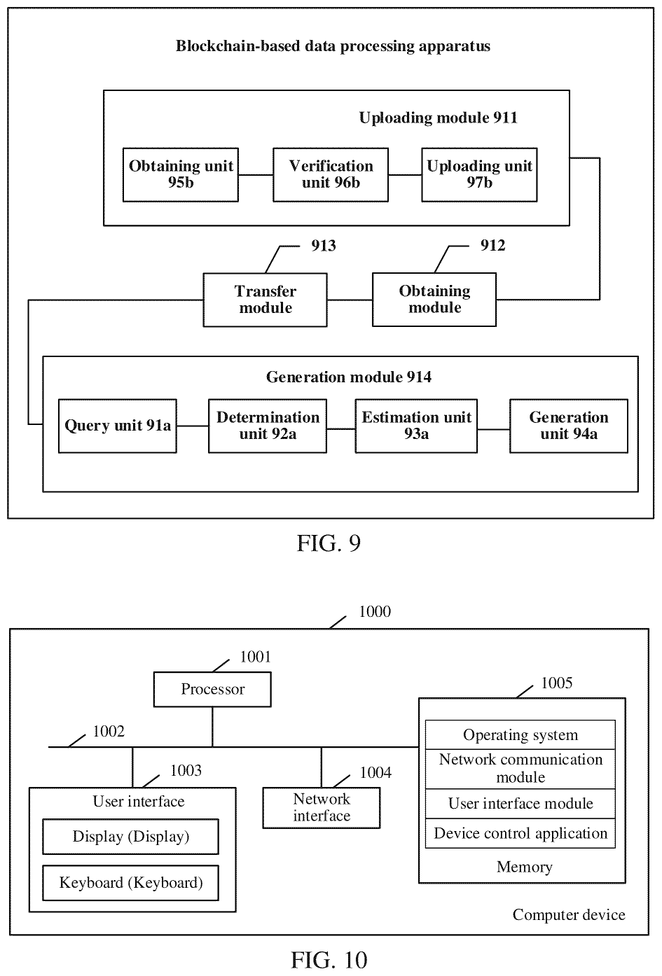

FIG. 10 is a schematic structural diagram of a computer device according to an embodiment of this disclosure. As shown in FIG. 10, a computer device 1000 may include a processor 1001, a network interface 1004, and a memory 1005. In addition, the computer device 1000 may further include a user interface 1003 and at least one communication bus 1002. The communication bus 1002 is configured to implement connection and communication between these components. The user interface 1003 may include a display and a keyboard. The user interface 1003 may further include a standard wired interface and a standard wireless interface. The network interface 1004 may include a standard wired interface and a standard wireless interface (such as a Wi-Fi interface). The memory 1005 may be a high-speed random access memory (RAM), or may be a non-volatile memory, for example, at least one disk memory. The memory 1005 may alternatively be at least one storage apparatus away from the processor 1001. As shown in FIG. 10, the memory 1005 serving as a computer-readable storage medium may include an operating system, a network communications module, a user interface module, and a device control application.

In the computer device 1000 shown in FIG. 10, the network interface 1004 may provide a network communication function. The user interface 1003 is mainly configured to provide an input interface. The processor 1001 may be configured to invoke the device control application stored in the memory 1005 to:
upload rental information regarding a virtual asset to a blockchain network; the rental information being configured for indicating that the virtual asset of a first object is in a rental pending state;
obtain a rental request generated for the rental information, the rental request carrying resource transfer information of the virtual asset, the resource transfer information including a numerical resource value of electronic resources to be transferred by a second object for renting the virtual asset;
transfer a target asset warrant of the virtual asset from an account address of the first object to an account address of the second object, and transfer the electronic resources of the numerical resource value from the account address of the second object to the account address of the first object, the target asset warrant being configured for indicating that the first object has an ownership for the virtual asset;
determine a warrant attribute corresponding to the target asset warrant, generate a rental contract regarding the virtual asset based on the warrant attribute and the resource transfer information, and upload the rental contract to the blockchain network, the rental contract being configured for indicating that the second object has a use permission for the virtual asset but does not have a transfer permission for the virtual asset.

In some embodiments, that the processor 1001 may be configured to invoke the device control application stored in the memory 1005 to determine a warrant attribute corresponding to the target asset warrant includes:
querying the blockchain network for asset warrants of the virtual asset to obtain a first asset warrant set, and counting a total quantity of the asset warrants in the first asset warrant set, the target asset warrant belonging to the first asset warrant set;
determining a unique warrant attribute as the warrant attribute of the target asset warrant if the total quantity of the asset warrants is 1, an object having the asset warrant with the unique warrant attribute having a full ownership for the virtual asset; and
determining a universal warrant attribute as the warrant attribute of the target asset warrant if the total quantity of the asset warrants is M, an object having the asset warrant with the universal warrant attribute having a partial ownership for the virtual asset, and M being a positive integer greater than or equal to 2.

In some embodiments, that the processor 1001 may be configured to invoke the device control application stored in the memory 1005 to generate a rental contract regarding the virtual asset based on the warrant attribute and the resource transfer information includes:
determining a first asset quantity of the virtual asset possessed by the first object based on the warrant attribute;
estimating an asset value of the virtual asset possessed by the first object based on the first asset quantity;
determining, based on the asset value and the resource transfer information, a rental period during which the second object rents the virtual asset;
generating first permission information of the first object for the virtual asset and second permission information of the second object for the virtual asset based on the rental period, the first permission information being configured for indicating that the first object does not have the ownership for the virtual asset within the rental period, and the second permission information being configured for indicating that the second object has the use permission for the virtual asset of the first asset quantity within the rental period but does not have the transfer permission for the virtual asset of the first asset quantity; and
generating the rental contract regarding the virtual asset based on the first permission information and the second permission information.

In some embodiments, that the processor 1001 may be configured to invoke the device control application stored in the memory 1005 to determine a first asset quantity of the virtual asset possessed by the first object based on the warrant attribute includes:
obtaining a total asset quantity of the virtual asset as a second asset quantity;
determining the second asset quantity as the first asset quantity of the virtual asset possessed by the first object if the warrant attribute is the unique warrant attribute; and
obtaining a share owned by the first object for the virtual asset from the blockchain network and determining the first asset quantity of the virtual asset possessed by the first object based on the second asset quantity and the share if the warrant attribute is the universal warrant attribute.

In some embodiments, that the processor 1001 may be configured to invoke the device control application stored in the memory 1005 to upload rental information regarding a virtual asset to a blockchain network includes:
obtaining a release request for the rental information regarding the virtual asset, the release request carrying the rental information of the virtual asset and an object identifier of the first object transmitting the release request;
determining a unit asset value of a unit asset quantity of the virtual asset based on the release request, and verifying validity of the release request based on the object identifier of the first object and the unit asset value; and
uploading the rental information regarding the virtual asset to the blockchain network if the release request is valid.

In some embodiments, that the processor 1001 may be configured to invoke the device control application stored in the memory 1005 to verify validity of the release request based on the object identifier of the first object and the unit asset value includes:
querying the blockchain network for asset warrants possessed by the first object based on the object identifier of the first object if the unit asset value is greater than the asset value threshold, to obtain a second asset warrant set;
querying the blockchain network for description information of the asset warrants in the second asset warrant set;
querying the second asset warrant set for an asset warrant of the virtual asset based on the description information; and
determining the queried asset warrant as the target asset warrant of the virtual asset and determining that the release request is valid if the asset warrant of the virtual asset is queried from the second asset warrant set.

In some embodiments, the rental contract is further configured for indicating a rental period during which the second object rents the virtual asset. The processor 1001 may be configured to invoke the device control application stored in the memory 1005 to:
obtain current system time;
return the target asset warrant of the virtual asset to the account address of the first object if the current system time does not fall within the rental period;
generate invalidity indication information indicating that the rental contract is in an invalidity state, and upload the invalidity indication information to the blockchain network; and
transmit the invalidity indication information to a first terminal corresponding to the first object and a second terminal corresponding to the second object, the invalidity indication information being further configured for indicating that the first object recovers the ownership for the virtual asset and that the second object loses the use permission for the virtual asset.

In some embodiments, the processor 1001 may be configured to invoke the device control application stored in the memory 1005 to:
obtain a transfer request for the virtual asset, the transfer request carrying an object identifier of a transferor;
query the blockchain network for transaction data associated with the virtual asset if the object identifier of the transferor is the same as the object identifier of the first object;
execute the transfer request for the virtual asset if the transaction data associated with the virtual asset includes the rental contract for the virtual asset and includes the invalidity indication information of the rental contract for the virtual asset; and
suspend the execution of the transfer request for the virtual asset if the transaction data associated with the virtual asset includes the rental contract for the virtual asset but does not include the invalidity indication information of the rental contract for the virtual asset.

In some embodiments, the processor 1001 may be configured to invoke the device control application stored in the memory 1005 to:
suspend the execution of the transfer request and generating transfer suspension indication information if the object identifier of the transferor is the same as the object identifier of the second object, the transfer suspension indication information being configured for indicating that the second object does not have the transfer permission for the virtual asset;
transmit the transfer suspension indication information to the second terminal corresponding to the second object, and upload the transfer request to the blockchain network; and
adjust a credit rating of the second object based on the transfer request to obtain an adjusted credit rating, and suspend the execution of the rental request of the second object if the adjusted credit rating is less than a rating threshold.

In some embodiments, the processor 1001 may be configured to invoke the device control application stored in the memory 1005 to:
obtain a joining request for a target game scene in a game application, and querying the blockchain network for a joining condition for joining the target game scene based on the joining request, the joining request being configured for instructing to add the second object to the target game scene;
obtain game attribute information of the second object regarding the game application, and verify validity of the joining request based on the game attribute information, the rental contract, and the joining condition of the target game scene;
generate joining permission information if the joining request is valid, the joining permission information being configured for indicating that the second object has a joining permission for the target game scene; and
upload the joining permission information to the blockchain network, and transmit the joining permission information to an application server of the game application, the joining permission information being configured for instructing the application server to add the second object to the target game scene.

In some embodiments, that the processor 1001 may be configured to invoke the device control application stored in the memory 1005 to verify validity of the joining request based on the game attribute information, the rental contract, and the joining condition of the target game scene includes:
determining, based on the rental contract, a rental period during which the second object rents the virtual asset and a first asset quantity of the virtual asset rented to the second object;
determining a game level of the second object in the game application based on the game attribute information, and querying, based on the game level, the joining condition of the target game scene for a virtual asset quantity limit required for the second object to join the target game scene;
obtaining generation time of the joining request if the first asset quantity is greater than the virtual asset quantity limit; and
determining that the joining request is valid if the generation time of the joining request falls within the rental period during which the second object rents the virtual asset.

In some embodiments, the processor 1001 may be configured to invoke the device control application stored in the memory 1005 to:
obtain an object registration request transmitted by a third terminal, the object registration request including an object identifier of a third object corresponding to the third terminal and an account address of the third object;
invoke a registration function in a smart contract in the blockchain network based on the object registration request;
obtain object attribute information of the third object based on the registration function, and verifying validity of the third object based on the attribute information of the third object; and
associatively store the account address corresponding to the third terminal and the object identifier corresponding to the third terminal in the blockchain network if the third object is valid.

In this disclosure, the computer device may upload the rental information regarding the virtual asset to the blockchain network. The rental information is configured for indicating that the virtual asset of the first object is in the rental pending state. In this case, any user registered with the blockchain network may view the rental information and determine whether to rent the virtual asset based on a need of the user. Further, the computer device may obtain the rental request generated based on the rental information, the rental request carrying the resource transfer information of the virtual asset, the resource transfer information including the numerical resource value of the electronic resources to be transferred by the second object for renting the virtual asset; and transfer the target asset warrant of the virtual asset from the account address of the first object to the account address of the second object, and transfer the electronic resources of the numerical resource value from the account address of the second object to the account address of the first object, the target asset warrant being configured for indicating that the first object has the ownership for the virtual asset. It may be learned that the blockchain network has recorded therein the rental information issued by the first object, the rental request transmitted by the second object, and the rental contract corresponding to the generated virtual asset during the renting of the virtual asset, and can further automatically update the permissions of the virtual assets possessed by the first object and the second object after the rental contract is generated and expires. On the one hand, security, reliability, transparency, and high credibility of the data information during the renting of the virtual asset is realized by using characteristics that it is difficult to tamper with the data of the blockchain network and the information recorded in the blockchain network is more authentic and reliable. On the other hand, if the first object has a spare virtual asset or the first object does not need to use the virtual asset possessed by the first object, the first object may rent the virtual asset possessed by the first object to the second object that needs the virtual asset, and the second object may transfer a specific rental fee to the first object, to improve the utilization rate of the virtual asset and the device resource utilization rate and operating efficiency of the node devices of the blockchain, and reduce the costs required by the second object to participate in the virtual asset ecosystem. Then the computer device may determine the warrant attribute corresponding to the target asset warrant, generate the rental contract regarding the virtual asset based on the warrant attribute and the resource transfer information, and upload the rental contract to the blockchain network, the rental contract being configured for indicating that the second object has the use permission for the virtual asset but does not have the transfer permission for the virtual asset. In addition, after the second object obtains the target asset warrant of the virtual asset, the second object has the use permission for the virtual asset, and may use the virtual asset to participate in an on-line activity (for example, an activity in a game application), but the second object does not have the transfer permission for the virtual asset. In other words, the second object cannot transfer the virtual asset to others for use. In this way, a problem that the virtual asset cannot be returned to the first object after the rental contract is invalidated can be avoided, and the rental security and fairness of the virtual asset can be ensured.

The computer device 1000 described in this embodiment of this disclosure can perform the foregoing description of the blockchain-based data processing method in the embodiment corresponding to FIG. 4 or FIG. 6, or perform the foregoing description of the blockchain-based data processing apparatus in the embodiment corresponding to FIG. 9. Details refer to the embodiments described herein. In addition, beneficial effects of using the same method are not described in detail herein.

An embodiment of this disclosure further provides a computer-readable storage medium. The computer-readable storage medium has a computer program executed by the foregoing blockchain-based data processing apparatus stored therein. The computer program includes program instructions. When executing the foregoing program instructions, the processor can perform the description of the blockchain-based data processing method in the foregoing embodiments corresponding to FIG. 4 and FIG. 6. Therefore, details refer to the embodiments described herein. In addition, beneficial effects of using the same method are not described in detail herein. For technical details not disclosed in the embodiment of the computer-readable storage medium involved in this disclosure, reference is made to the description of the method embodiment of this disclosure.

In an example, the program instructions may be deployed on one computer device for execution, or deployed on at least two computer devices at one site for execution, or executed on at least two computer devices distributed at at least two locations and connected by a communication network. The at least two computer devices distributed at the at least two locations and connected by the communication network can form a blockchain network.

The foregoing computer-readable storage medium may be an internal storage unit in the blockchain-based data processing apparatus provided in any one of the foregoing embodiments or the foregoing computer device, for example, a hard disk or an internal memory of the computer device. The computer-readable storage medium may alternatively be an external storage device of the computer device, for example, a plug-in hard disk, a smart media card (SMC), a secure digital (SD) card, and a flash card equipped on the computer device. Further, the computer-readable storage medium may further include both the internal storage unit and the external storage device of the computer device. The computer-readable storage medium is configured to store the computer program and other programs and data required by the computer device. The computer-readable storage medium may be further configured to temporarily store data that has been outputted or that is to be outputted.

Terms such as “first” and “second” in the specification and claims of the embodiments of this disclosure and the drawings are configured for distinguishing between different medium contents, rather than describing a specific order. Moreover, the term “include” and any variation thereof are intended to cover non-exclusive inclusions. For example, processes, methods, apparatuses, products, or devices including a series of operations or modules are not limited to the listed operations or modules, but instead, include operations or modules not listed, or include other operations or units inherent to these processes, methods, apparatuses, products, or devices.

An embodiment of this disclosure further provides a computer program product, including a computer program/instruction. The computer program/instruction, when executed by a processor, implements the foregoing description of the foregoing blockchain-based data processing method in the embodiments corresponding to FIG. 4 and FIG. 2. Therefore, details refer to the embodiments described herein. In addition, beneficial effects of using the same method are not described in detail herein. For technical details not disclosed in the embodiment of the computer program product involved in this disclosure, reference is made to the description of the method embodiment of this disclosure.

A person of ordinary skill in the art may realize that operations of units and algorithms of various examples described with reference to the embodiments disclosed in this specification may be implemented in electronic hardware, computer software, or a combination of the electronic hardware and the computer software. In order to clearly describe the interchangeability of hardware and software, the compositions and operations of the various examples are generally described in terms of functionality in the foregoing description. Whether the functions are performed by hardware or software depends on specific applications and design constraints of the technical solutions. A person skilled in the art may use different methods to implement the described functions for each particular application, but it is not to be considered that the implementation goes beyond the scope of this disclosure.

The method and the related apparatus provided in the embodiments of this disclosure are described with reference to the method flowcharts and/or schematic structural diagrams provided in the embodiments of this disclosure. Specifically, each process and/or block in the method flowcharts and/or schematic structural diagrams and a combination of processes and/or blocks in the flowcharts and/or block diagrams may be implemented through computer program instructions. These computer program instructions may be provided to a processor of a general-purpose computer, a special-purpose computer, an embedded processing machine, or another programmable network connection device to generate a machine, so that instructions executed by the processor of the computer or the another programmable network connection device generate an apparatus for implementing functions specified in one or more processes of the flowcharts and/or one or more blocks of the schematic structural diagrams. These computer program instructions may alternatively be stored in a computer-readable memory that can direct the computer or the another programmable network connection device to operate in such a way that the instructions stored in the computer-readable memory generate an article of manufacture including an instruction apparatus which implements the functions specified in one or more processes of the flowcharts and/or one or more blocks of the schematic structural diagrams. These computer program instructions may alternatively be loaded onto the computer or the another programmable network connection device, so that a series of operations and operations are performed on the computer or the another programmable device, thereby generating computer-implemented processing. Therefore, the instructions executed on the computer or the another programmable device provide operations for implementing the functions specified in one or more processes of the flowcharts and/or one or more blocks of the schematic structural diagrams.

What is disclosed above is merely exemplary embodiments of this disclosure, and certainly is not intended to limit the protection scope of this disclosure. Therefore, equivalent variations made in accordance with the claims of this disclosure still fall within the scope of this disclosure.

What is claimed is:

1. A blockchain-based data processing method, performed by a computer device, the method comprising:
uploading rental information regarding a virtual asset to a blockchain network, the rental information being for indicating that the virtual asset of a first object is in a rental pending state;
obtaining a rental request generated for the rental information, the rental request carrying resource transfer information of the virtual asset, the resource transfer information comprising a numerical resource value of electronic resources to be transferred by a second object for renting the virtual asset;
transferring a target asset warrant of the virtual asset from an account address of the first object to an account address of the second object, and transferring the electronic resources of the numerical resource value from the account address of the second object to the account address of the first object, the target asset warrant being for indicating that the first object has an ownership for the virtual asset; and
determining a warrant attribute corresponding to the target asset warrant, generating a rental transaction record regarding the virtual asset based on the warrant attribute and the resource transfer information, and uploading the rental transaction record to the blockchain network, the rental transaction record being for indicating that the second object has a use permission for the virtual asset but does not have a transfer permission for the virtual asset.

2. The method according to claim 1, wherein the determining the warrant attribute corresponding to the target asset warrant comprises:
querying the blockchain network for asset warrants of the virtual asset to obtain a first asset warrant set, and counting a total quantity of the asset warrants in the first asset warrant set, the target asset warrant belonging to the first asset warrant set;
determining that the warrant attribute of the target asset warrant is a first warrant attribute in response to the total quantity of the asset warrants in the first asset warrant set being 1, an object having the asset warrant with the first warrant attribute having a full ownership for the virtual asset; and
determining that the warrant attribute of the target asset warrant is a second warrant attribute in response to the total quantity of the asset warrants in the first asset warrant set being M, an object having one asset warrant with the second warrant attribute having a partial ownership for the virtual asset, and M being a positive integer greater than or equal to 2.

3. The method according to claim 2, wherein the generating the rental transaction record regarding the virtual asset based on the warrant attribute and the resource transfer information comprises:
determining a first asset quantity of the virtual asset possessed by the first object based on the warrant attribute;
estimating an asset value of the virtual asset possessed by the first object based on the first asset quantity;
determining, based on the asset value and the resource transfer information, a rental period during which the second object rents the virtual asset;
generating first permission information of the first object for the virtual asset and second permission information of the second object for the virtual asset based on the rental period, the first permission information being for indicating that the first object does not have the ownership for the virtual asset within the rental period, and the second permission information being for indicating that the second object has the use permission for the virtual asset of the first asset quantity within the rental period and does not have the transfer permission for the virtual asset of the first asset quantity; and
generating the rental transaction record regarding the virtual asset based on the first permission information and the second permission information.

4. The method according to claim 3, wherein the determining the first asset quantity of the virtual asset possessed by the first object based on the warrant attribute comprises:
obtaining a total asset quantity of the virtual asset as a second asset quantity;
determining the second asset quantity as the first asset quantity of the virtual asset possessed by the first object in response to the warrant attribute being the first warrant attribute; and
obtaining a share owned by the first object for the virtual asset from the blockchain network and determining the first asset quantity of the virtual asset possessed by the first object based on the second asset quantity and the share in response to the warrant attribute being the second warrant attribute.

5. The method according to claim 1, wherein the uploading the rental information regarding a virtual asset to a blockchain network comprises:
obtaining a release request for the rental information regarding the virtual asset, the release request carrying the rental information of the virtual asset and an object identifier of the first object transmitting the release request;
determining a unit asset value corresponding to a unit asset quantity of the virtual asset based on the release request, and verifying validity of the release request based on the object identifier of the first object and the unit asset value; and
uploading the rental information regarding the virtual asset to the blockchain network in response to the release request being valid.

6. The method according to claim 5, wherein the verifying the validity of the release request based on the object identifier of the first object and the unit asset value comprises:
in response to the unit asset value being greater than an asset value threshold, querying the blockchain network for asset warrants possessed by the first object based on the object identifier of the first object, to obtain a second asset warrant set of the first object;
querying the blockchain network for description information of the asset warrants in the second asset warrant set, the description information being for indicating virtual assets to which the asset warrants in the second asset warrant set respectively belong;
querying the second asset warrant set for an asset warrant of the virtual asset based on the description information; and
determining the queried asset warrant as the target asset warrant of the virtual asset and determining that the release request is valid in response to the asset warrant of the virtual asset being queried from the second asset warrant set.

7. The method according to claim 1, wherein the rental transaction record is further for indicating a rental period during which the second object rents the virtual asset, and the method further comprises:
obtaining current system time;
returning the target asset warrant of the virtual asset to the account address of the first object in response to the current system time failing to fall within the rental period;
generating invalidity indication information indicating that the rental transaction record is in an invalidity state, and uploading the invalidity indication information to the blockchain network; and
transmitting the invalidity indication information to a first terminal corresponding to the first object and a second terminal corresponding to the second object, the invalidity indication information being further for indicating that the first object recovers the ownership for the virtual asset and that the second object loses the use permission for the virtual asset.

8. The method according to claim 7, further comprising:
obtaining a transfer request for the virtual asset, the transfer request carrying an object identifier of a transferor;
querying the blockchain network for transaction data associated with the virtual asset in response to the object identifier of the transferor being same as the object identifier of the first object;
executing the transfer request for the virtual asset in response to the transaction data associated with the virtual asset comprising the rental transaction record for the virtual asset and comprising the invalidity indication information of the rental transaction record for the virtual asset; and
suspending the execution of the transfer request for the virtual asset in response to the transaction data associated with the virtual asset comprising the rental transaction record for the virtual asset but not comprising the invalidity indication information of the rental transaction record for the virtual asset.

9. The method according to claim 8, further comprising:
suspending the execution of the transfer request and generating transfer suspension indication information in response to the object identifier of the transferor being same as the object identifier of the second object, the transfer suspension indication information being for indicating that the second object does not have the transfer permission for the virtual asset;
transmitting the transfer suspension indication information to the second terminal corresponding to the second object, and uploading the transfer request to the blockchain network; and
adjusting a credit rating of the second object based on the transfer request to obtain an adjusted credit rating, and suspending the execution of the rental request of the second object in response to the adjusted credit rating being less than a rating threshold.

10. The method according to claim 1, further comprising:
obtaining a joining request for a target game scene in a game application, and querying the blockchain network for a joining condition for joining the target game scene based on the joining request, the joining request being for instructing to add the second object to the target game scene;
obtaining game attribute information of the second object regarding the game application, and verifying validity of the joining request based on the game attribute information, the rental transaction record, and the joining condition of the target game scene;
generating joining permission information in response to the joining request being valid, the joining permission information being for indicating that the second object has a joining permission for the target game scene; and
uploading the joining permission information to the blockchain network, and transmitting the joining permission information to an application server of the game application, the joining permission information being for instructing the application server to add the second object to the target game scene.

11. The method according to claim 10, wherein the verifying validity of the joining request based on the game attribute information, the rental transaction record, and the joining condition of the target game scene comprises:
determining, based on the rental transaction record, a rental period during which the second object rents the virtual asset and a first asset quantity of the virtual asset rented to the second object;
determining a game level of the second object in the game application based on the game attribute information, and querying, based on the game level, the joining condition of the target game scene for a virtual asset quantity limit required for the second object to join the target game scene;
obtaining generation time of the joining request in response to the first asset quantity being greater than the virtual asset quantity limit; and
determining that the joining request is valid in response to the generation time of the joining request falling within the rental period during which the second object rents the virtual asset.

12. The method according to claim 1, further comprising:
obtaining an object registration request transmitted by a third terminal, the object registration request comprising an object identifier of a third object corresponding to the third terminal and an account address of the third object;
invoking a registration function in the blockchain network based on the object registration request;
obtaining object attribute information of the third object based on the registration function, and verifying validity of the third object based on the attribute information of the third object; and
associatively storing the account address corresponding to the third terminal and the object identifier corresponding to the third terminal in the blockchain network in response to the third object being valid.

13. A blockchain-based data processing apparatus, comprising:
a memory operable to store computer-readable instructions; and
a processor circuitry operable to read the computer-readable instructions, the processor circuitry when executing the computer-readable instructions is configured to:
upload rental information regarding a virtual asset to a blockchain network, the rental information being for indicating that the virtual asset of a first object is in a rental pending state;
obtain a rental request generated for the rental information, the rental request carrying resource transfer information of the virtual asset, the resource transfer information comprising a numerical resource value of electronic resources to be transferred by a second object for renting the virtual asset;
transfer a target asset warrant of the virtual asset from an account address of the first object to an account address of the second object, and transfer the electronic resources of the numerical resource value from the account address of the second object to the account address of the first object, the target asset warrant being for indicating that the first object has an ownership for the virtual asset; and
determine a warrant attribute corresponding to the target asset warrant, generate a rental transaction record regarding the virtual asset based on the warrant attribute and the resource transfer information, and upload the rental transaction record to the blockchain network, the rental transaction record being for indicating that the second object has a use permission for the virtual asset but does not have a transfer permission for the virtual asset.

14. The apparatus according to claim 13, wherein the processor circuitry is configured to:
query the blockchain network for asset warrants of the virtual asset to obtain a first asset warrant set, and counting a total quantity of the asset warrants in the first asset warrant set, the target asset warrant belonging to the first asset warrant set;
determine that the warrant attribute of the target asset warrant is a first warrant attribute in response to the total quantity of the asset warrants in the first asset warrant set being 1, an object having the asset warrant with the first warrant attribute having a full ownership for the virtual asset; and
determine that the warrant attribute of the target asset warrant is a second warrant attribute in response to the total quantity of the asset warrants in the first asset warrant set being M, an object having one asset warrant with the second warrant attribute having a partial ownership for the virtual asset, and M being a positive integer greater than or equal to 2.

15. The apparatus according to claim 13, wherein the processor circuitry is configured to:
obtain a release request for the rental information regarding the virtual asset, the release request carrying the rental information of the virtual asset and an object identifier of the first object transmitting the release request;
determine a unit asset value corresponding to a unit asset quantity of the virtual asset based on the release request, and verify validity of the release request based on the object identifier of the first object and the unit asset value; and
upload the rental information regarding the virtual asset to the blockchain network in response to the release request being valid.

16. The apparatus according to claim 13, wherein the processor circuitry is configured to:
obtain current system time;
return the target asset warrant of the virtual asset to the account address of the first object in response to the current system time failing to fall within the rental period;
generate invalidity indication information indicating that the rental transaction record is in an invalidity state, and upload the invalidity indication information to the blockchain network; and
transmit the invalidity indication information to a first terminal corresponding to the first object and a second terminal corresponding to the second object, the invalidity indication information being further for indicating that the first object recovers the ownership for the virtual asset and that the second object loses the use permission for the virtual asset.

17. The apparatus according to claim 16, wherein the processor circuitry is further configured to:
obtain a transfer request for the virtual asset, the transfer request carrying an object identifier of a transferor;
query the blockchain network for transaction data associated with the virtual asset in response to the object identifier of the transferor being same as the object identifier of the first object;
execute the transfer request for the virtual asset in response to the transaction data associated with the virtual asset comprising the rental transaction record for the virtual asset and comprising the invalidity indication information of the rental transaction record for the virtual asset; and
suspend the execution of the transfer request for the virtual asset in response to the transaction data associated with the virtual asset comprising the rental transaction record for the virtual asset but not comprising the invalidity indication information of the rental transaction record for the virtual asset.

18. The apparatus according to claim 13, wherein the processor circuitry is further configured to:
obtain a joining request for a target game scene in a game application, and query the blockchain network for a joining condition for joining the target game scene based on the joining request, the joining request being for instructing to add the second object to the target game scene;
obtain game attribute information of the second object regarding the game application, and verify validity of the joining request based on the game attribute information, the rental transaction record, and the joining condition of the target game scene;
generate joining permission information in response to the joining request being valid, the joining permission information being for indicating that the second object has a joining permission for the target game scene; and
upload the joining permission information to the blockchain network, and transmit the joining permission information to an application server of the game application, the joining permission information being for instructing the application server to add the second object to the target game scene.

19. The apparatus according to claim 13, wherein the processor circuitry is further configured to:
obtain an object registration request transmitted by a third terminal, the object registration request comprising an object identifier of a third object corresponding to the third terminal and an account address of the third object;
invoke a registration function in the blockchain network based on the object registration request;
obtain object attribute information of the third object based on the registration function, and verify validity of the third object based on the attribute information of the third object; and
associatively store the account address corresponding to the third terminal and the object identifier corresponding to the third terminal in the blockchain network in response to the third object being valid.

20. A non-transitory machine-readable media, having instructions stored on the machine-readable media, the instructions configured to, when executed, cause a machine to:
upload rental information regarding a virtual asset to a blockchain network, the rental information being for indicating that the virtual asset of a first object is in a rental pending state;
obtain a rental request generated for the rental information, the rental request carrying resource transfer information of the virtual asset, the resource transfer information comprising a numerical resource value of electronic resources to be transferred by a second object for renting the virtual asset;
transfer a target asset warrant of the virtual asset from an account address of the first object to an account address of the second object, and transfer the electronic resources of the numerical resource value from the account address of the second object to the account address of the first object, the target asset warrant being for indicating that the first object has an ownership for the virtual asset; and
determine a warrant attribute corresponding to the target asset warrant, generate a rental transaction record regarding the virtual asset based on the warrant attribute and the resource transfer information, and upload the rental transaction record to the blockchain network, the rental transaction record being for indicating that the second object has a use permission for the virtual asset but does not have a transfer permission for the virtual asset.
